(19) United States
(12) Patent Application Publication
(10) Pub. No.: US 2026/0116750 A1
(43) Pub. Date: Apr. 30, 2026

(54) METHODS AND SYSTEMS FOR FACILITATING OXYGEN-ENRICHED PARTIAL OXIDATION REACTIONS TO CONVERT HYDROCARBONS INTO CARBON MONOXIDE AND HYDROGEN

(71) Applicant: Emvolon, Inc., Woburn, MA (US)

(72) Inventors: Leslie BROMBERG, Sharon, MA (US); Yu CHEN, Somerville, MA (US); Georgios GIANNAKAKIS, Zurich (CH); Emmanouil KASSERIS, Reading, MA (US); Scott MACADAM, Katy, TX (US); Colin Armstrong PAVAN, Waltham, MA (US); Yicheng SI, Cambridge, MA (US); Vasileios TRIANTOPOULOS, Boston, MA (US)

(21) Appl. No.: 19/374,441

(22) Filed: Oct. 30, 2025

Related U.S. Application Data
(63) Continuation of application No. PCT/US2025/053172, filed on Oct. 29, 2025.
(60) Provisional application No. 63/713,367, filed on Oct. 29, 2024.

(51) Int. Cl. C01B 3/36; B01D 53/02; B01J 4/00; B01J 12/00; B01J 19/24; F02D 13/02; F02M 21/02

(52) U.S. Cl. CPC C01B 3/366; B01D 53/02; B01J 4/008; B01J 12/00; B01J 19/24; F02D 13/02; F02M 21/0287; B01D 2256/12; B01D 2257/102; B01J 2204/002; B01J 2219/00164; C01B 2203/0255; C01B 2203/1241; C01B 2203/169; C01B 2203/84

(57) ABSTRACT

A non-transitory, processor readable medium stores instructions that, when executed by a processor, causes the processor to receive (1) an indication of a feed gas flow rate measured between a feed gas source and an internal combustion engine (ICE) and (2) an indication of an oxygen enriched air flow rate measured between an air separation unit (ASU) and the ICE. A measured equivalence ratio is determined based on a feed gas composition, the feed gas flow rate, and the oxygen enriched air flow rate. The instructions further cause the processor to generate at least one of a first signal to cause a change in revolution speed of the ICE, a second signal to cause a first flow control device to modify the feed gas flow rate, or a third signal to cause a second flow control device to modify the oxygen enriched air flow rate.

### CROSS-REFERENCE TO RELATED APPLICATIONS

This application is a continuation of International Patent Application No. PCT/US2025/053172, filed on Oct. 29, 2025, entitled “Methods and Systems for Facilitating Oxygen-Enriched Partial Oxidation Reactions to Convert Hydrocarbons into Carbon Monoxide and Hydrogen,” which claims priority to and the benefit of U.S. Provisional Patent Application No. 63/713,367, filed on Oct. 29, 2024, and titled “Methods and Systems for Facilitating Oxygen-Enriched Partial Oxidation Reactions to Convert Hydrocarbons into Carbon Monoxide and Hydrogen,” the contents of which are incorporated by reference herein in their entireties.

### TECHNICAL FIELD

One or more embodiments described herein relate to systems and methods for facilitating oxygen-enriched partial oxidation (POX) reactions to convert hydrocarbons into carbon monoxide and hydrogen.

### BACKGROUND

Gaseous hydrocarbons are generated as byproducts from a variety of sources, including oil and gas production, refinery fuel gas, petrochemical off-gas streams, landfills, anaerobic digesters, and renewable natural gas (RNG) upgrading facilities (e.g., tail gas from a nitrogen rejection unit). These gases, which can also be referred to herein as stranded gases, may contain methane as a major component, along with substantial concentrations and/or fractions of carbon dioxide (CO₂), nitrogen (N₂), hydrogen (H₂), oxygen (O₂), and higher hydrocarbons depending on the source. For example, landfill gas and biogas from anaerobic digesters often contain 40-60% methane, 40-60% carbon dioxide, and varying levels of N₂ and O₂. Tail gas from RNG upgrading facilities can contain a high fraction of methane with elevated nitrogen levels. Hydrocarbon-rich streams from oil and gas production and refining may include methane as well as higher hydrocarbons such as ethane, propane, n-butane, isobutane, n-pentane, isopentane, n-hexane, and light olefins (e.g., ethylene, propylene, 1-butene), while refinery and petrochemical off-gases often contain significant hydrogen along with methane, C₂-C₄ hydrocarbons, and other impurities. Capturing and transporting stranded gases using conventional infrastructure is technically challenging and economically prohibitive due to their low pressures, variable compositions, and dispersed locations. As a result, stranded gases are frequently flared or vented, releasing potent greenhouse and pollutant gases and representing a missed opportunity to recover value from these resources.

Gas-to-liquid (GTL) processes can offer an approach to convert gaseous hydrocarbons into liquid products, which can be a more convenient to handle, store, and/or transport. In general, GTL processes are known to convert gaseous hydrocarbons into liquid fuels and chemicals through multiple stages. GTL processes typically include (i) reforming a feed of gaseous hydrocarbons into synthesis gas (syngas) containing hydrogen and carbon monoxide, (ii) conditioning the syngas to adjust its pressure, temperature, composition and reduce contaminants, and (ii) catalytically reacting the syngas to synthesize liquid products such as methanol, Fischer-Tropsch hydrocarbons, or other oxygenates.

The present disclosure focuses on a subsystem of the GTL process, namely the reforming of gaseous hydrocarbons into synthesis gas and innovations related to such reforming operations. The reforming may be carried out by partial oxidation (POX), steam reforming, dry reforming, reverse water-gas shift (RWGS), water-gas shift (WGS), or by a combination of these reactions, and may involve engine-based or non-engine reactors, as further disclosed herein.

Depending on the source, gaseous hydrocarbon feeds are often reported to contain species that can damage or degrade GTL equipment. For example, landfill gas is known to contain siloxanes, and/or sulfur compounds. Siloxanes can form abrasive deposits in reformers, while sulfur compounds are known to poison catalysts. Even when not directly damaging GTL equipment, components such as carbon dioxide, a species commonly found in high concentrations in landfill gas and digester gas, can reduce process efficiency and product yield. Accordingly, many conventional GTL systems are designed to include pretreatment steps to reduce such species to acceptable levels before reforming.

Conventional GTL systems, however, are typically cost-ineffective at smaller scales and can be unfeasible for applications such as managing gas stranded at shale wells, or gases generated at landfill facilities and digesters. Additionally, some conventional and/or known GTL systems include an engine reformer (e.g., an internal combustion engine) which has been configured to convert gaseous hydrocarbons into syngas via POX reactions using oxygen in air as a reactant. These GTL systems can be inefficient. More specifically, because air includes approximately 79% N₂, and the O₂ reactant present in air is significantly diluted. The low concentration of O₂ in air reduces the efficiency of the POX engine reformer (also referred to herein as a POX engine, POX reformer, and/or POX engine reactor), which in turn reduces product yield and increases costs. Moreover, the POX reactions used to reform gaseous hydrocarbons are typically fuel rich, necessitating only a minimal oxidant quantity to produce syngas suitable for liquid synthesis. The high concentration of N₂ in air dilutes this fuel-rich mixture, which in turn reduces the flame temperature and the ability of the flame to propagate at higher relative fuel-to-air ratios (FARs). As a result, some known air-breathing and/or air-fired POX engine reactors (e.g., a POX engine reactor that operates in ambient air) require extensive pre-heating of the mixture to temperatures exceeding 250° C. This pre-heating increases energy costs, reduces throughput due to lowered gas density at elevated temperatures, and/or introduces potential safety hazards.

Another drawback of known air-breathing POX engine reactors is that the maximum fuel-to-air equivalence ratio is limited, resulting in synthesis gas having less H₂ and, therefore, lower quality, and/or reduced product yield. Additionally, due to the presence of the N₂, recycling of unreacted gases after the gas-to-liquids reactor is at least limited, resulting in further limited yields.

In summary, utilizing air as an oxidant can introduce inert gases (e.g., N₂), the handling of which can cause some known GTL systems to be excessively costly, large (e.g., in footprint, capacity, volume, or the like to offset reduced product yield), and/or cumbersome for processing relatively small amounts of stranded gas. There is a need, therefore, for systems and methods appropriate for use in small-scale stranded gas applications. Such systems and methods can use oxygen-enriched air to reduce intake of inert gas into the POX engine reactor.

Because oxygen-enriched air streams contain significantly higher oxygen concentrations, the partial oxidation process releases more energy than air-breathing systems. This higher energy release increases the shaft power available from the POX engine reactor (or other engine-based reformers) during operation. Harvesting this additional power is important for the overall GTL system, as many subsystems—including compression, separation, and controls—require substantial electrical or mechanical input. Accordingly, one aspect of the present disclosure is the control of oxygen-enriched POX engine reactor not only to improve syngas quality, but also to enable the POX engine reactor to function as a power generator within the GTL system. In some embodiments, control of the POX engine reactor may be coordinated with system-level load demand changes, such that the reformer engine dynamically supplies both synthesis gas and power to meet the operational needs of the integrated GTL system.

The significantly higher concentrations of oxygen present in oxygen-enriched air streams compared to ambient air allow greater amounts of feed gas to be processed under fuel-rich conditions. Consequently, for a given engine size, manifold pressure, and engine speed, the POX reactions release more energy for enriched-air POX engine reactors than for air-breathing POX engine reactors. This energy release translates into shaft power available from the POX engine reactor (or other engine-based reformers) during operation. Harvesting this power is important for the overall GTL system, as many subsystems, including compression, separation, and controls, require substantial power input. Accordingly, one aspect of the present disclosure is the control of oxygen-enriched POX engine reactors not only to improve syngas quality, but also to enable the POX engine reactor to function as a power generator within the GTL system. In some embodiments, the control of the POX engine reactor may be coordinated with system-level load demand changes, such that the reformer engine dynamically supplies both synthesis gas and power to meet the operational needs of the integrated GTL system.

### SUMMARY

Systems, devices, and methods are described herein for facilitating oxygen-enriched partial oxidation (POX) reactions to convert hydrocarbons into carbon monoxide and hydrogen.

In some embodiments, an apparatus comprises an engine including a reactor chamber, and a plurality of inlets coupled to the reactor chamber. The plurality of inlets includes a first inlet configured to deliver a reactant stream, and at least two oxidizer inlets configured to deliver at least two oxidizer streams of differing state variables. The reactor chamber is configured to receive the reactant stream and the at least two oxidizer streams to support a reaction therebetween to produce a product.

In some embodiments, a method of operating a reactor comprises supplying a reactant stream to a reactor chamber included in the reactor. The method further comprises supplying at least two oxidizer streams of differing state variables to the reactor chamber. The at least two oxidizer streams can be supplied individually or in combination. The method further comprises supporting a reaction between the reactant stream and the at least two oxidizer streams in the reactor chamber to produce a product.

In some embodiments, a control system for a reactor comprises a plurality of flow control devices, one or more sensors, and a controller. The plurality of flow control devices can be configured to regulate at least two oxidizer streams of differing state variables. The one or more sensors can be configured to measure one or more parameters of the at least two oxidizer streams, the reactor operation, or both. The controller can be operably coupled to the plurality of flow control devices and the one or more sensors. The controller can be configured to recognize differences between the at least two oxidizer streams based on their state variable, and adjust a flow of the at least two oxidizer streams supplied to a reactor chamber in response to the measured one or more parameters.

### BRIEF DESCRIPTION OF THE DRAWINGS

FIG. 1 shows a block diagram of a first example implementation of a feed gas reforming system, according to an embodiment.

FIG. 2 shows a block diagram of a second example implementation of a feed gas reforming system, according to an embodiment.

FIG. 3 shows a block diagram of a third example implementation of a feed gas reforming system, according to an embodiment.

FIG. 4 shows a block diagram of a first example configuration of control components included in a gas reforming system, according to an embodiment.

FIG. 5 shows a block diagram of a second example configuration of control components included in a gas reforming system, according to an embodiment.

FIG. 6 shows a block diagram of a third example configuration of control components included in a gas reforming system, according to an embodiment.

FIG. 7 shows a block diagram of a compute device included in a feed gas reforming system, according to an embodiment.

FIG. 8 shows a flow diagram of an example control scheme for a feed gas reforming system, according to an embodiment.

FIG. 9 shows a block diagram of a gas-to-liquid (GTL) methanol synthesis system that includes a feed gas reforming system, according to an embodiment.

### DETAILED DESCRIPTION

At least some systems and methods described herein can use oxygen-enriched air as an oxidant for an internal combustion engine as a partial oxidation (POX) reactor to reduce capital and operational costs for use in small-scale stranded gas applications. More specifically, relative to the use of air as an oxidant, the use of oxygen enriched air can (1) increase product yield due to lack of or decreased N₂ dilution; (2) increase flame/reaction temperature, which can reduce or eliminate (a) the need for preheating and (b) the associated yield penalty that can arise from lower density; (3) increase fuel-air ratios (FARs), which can increase (hydrogen) H₂ concentrations and/or a ratio of H₂ and carbon monoxide (CO) (e.g., a H₂—CO ratio) of the synthesis gas (syngas), which in turn can increase the quality of the syngas; (4) reduce the size, footprint, volume, and/or weight of the gas-to-liquid system for the same throughput; (5) enable use of fuel associated with a lower heating value (e.g., biogas that contains carbon dioxide or CO₂); and/or (6) reduce the introduction of N₂ as a dilutant to enable or improve recycling of unreacted gases. Oxygen-enriched air used as an oxidant in a POX engine reactor to reform feed gas into syngas can be generated by an air separation unit (ASU).

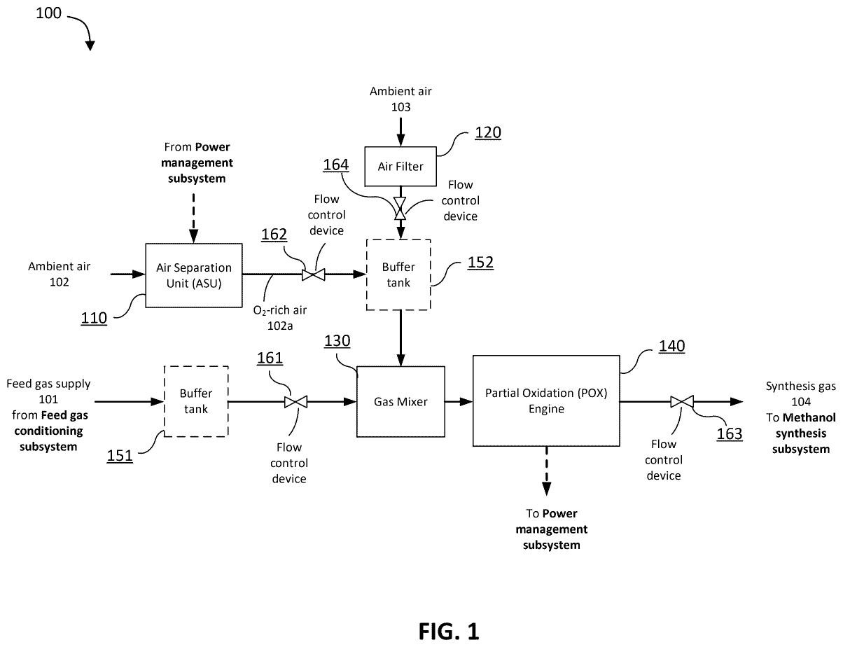

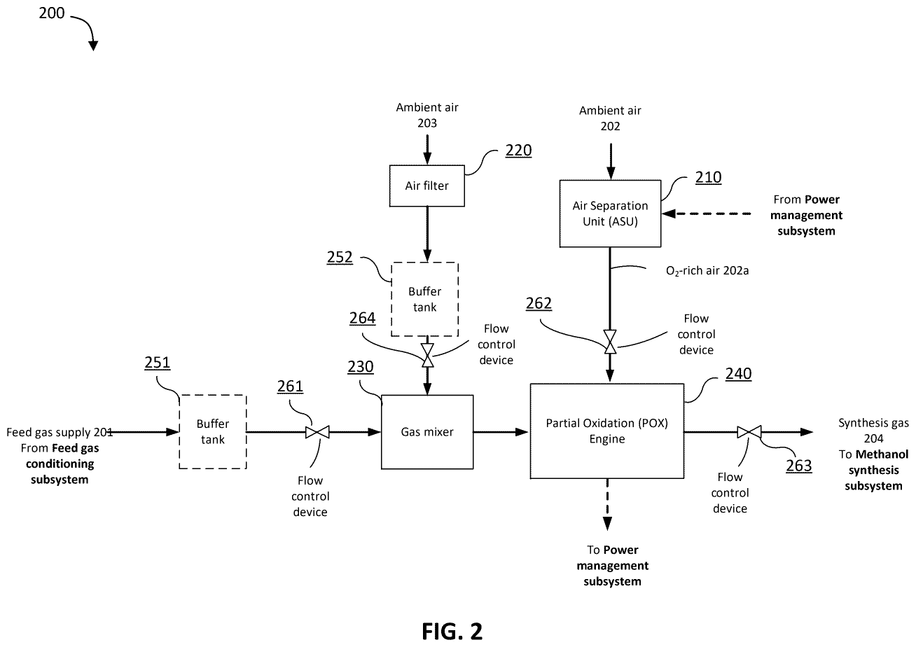

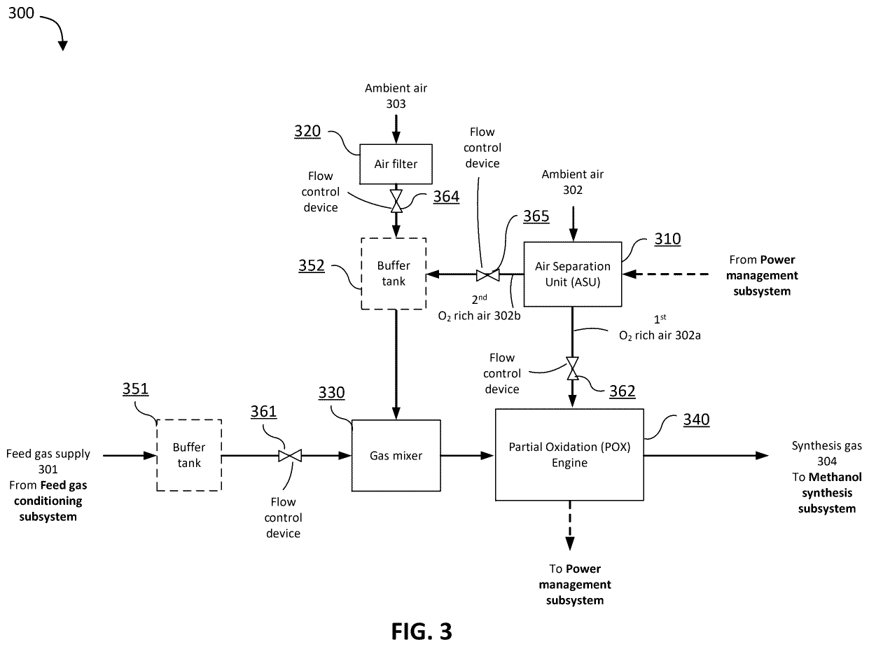

FIG. 1 shows a block diagram of a feed gas reforming system 100, according to an embodiment. FIGS. 2-3 show block diagrams of feed gas reforming systems 200-300, which can be alternative embodiments to the feed gas reforming system 100, as described further herein. Dashed arrows depicted in FIGS. 1-3 can represent power (e.g., electrical power) inputs and outputs. More specifically, the dashed arrows can represent a major portion and/or fraction of (a) the power input, load, and/or consumption associated with components of the feed gas reforming systems 100-300, and/or (b) the power produced by components of the feed gas reforming systems 100-300. The solid arrows depicted in FIGS. 1-3 can represent material flow (e.g., gas flow; air flow, etc.). FIG. 1 shows the feed gas reforming system 100 can include an air separation unit (ASU) 110, an ambient air intake and/or air filter 120, a gas mixer 130, a partial oxidation (POX) engine reactor 140, and flow control devices 161, 162, and 164. Optionally, in some embodiments the feed gas reforming system 100 can also include flow control device 163 and buffer tanks 151 and 152. The feed gas reforming system 100 can be configured to receive a feed gas supply 101, an ambient air stream 102, and an ambient air stream 103; and process the received streams to produce a synthesis gas 104, as further disclosed herein. The feed gas supply 101 can be and/or include a stream of gaseous hydrocarbons pretreated or unpretreated, which can be directed to the gas mixer 130 with the aid of the flow control device 161. In some embodiments, the feed gas supply 101 can be and/or include a pretreated or unpretreated stranded gas. In some embodiments, the feed gas supply 101 can be and/or include a hydrocarbon-rich fuel gas containing and/or including methane, ethane, butane, isobutane, and/or pentane, N₂, CO₂, O₂, or a combination thereof. In some embodiments, the feed gas supply 101 can be and/or include landfill gas, biogas, or tail gas from a nitrogen rejection unit in a renewable natural gas upgrading facility. In some embodiments, the feed gas supply 101 can be fluidically coupled and/or communicated with the optional buffer tank 151, which is disposed upstream from the gas mixer 130, as shown in FIG. 1. The optional buffer tank 151 can be any suitable receptacle and/or container configured to contain and/or store a volume or quantity of the feed gas supply 101 and then deliver the feed gas supply 101 to the gas mixer 130 as needed. Optionally, in some embodiments, the feed gas supply 101 may be introduced directly into the POX engine reactor 140 (e.g., bypassing the gas mixer 130, not shown in FIG. 1). In such embodiments, the flow control device 161 can be configured as a direct injector, enabling complete or partially direct injection of the feed gas supply 101 into the reactor chamber of the POX reactor 140.

The ASU 110 can be a gas separation device configured to receive and process the ambient air stream 102 to produce an oxygen-enriched air stream 102a, as further disclosed herein. In some embodiments, the oxygen-enriched air stream 102a produced by the ASU 110 can be directed, with the aid of the flow control device 162, to the optional buffer tank 152. Alternatively, in some embodiments the oxygen-enriched air stream 102a produced by the ASU 110 can be directly sent to the gas mixer 130 (not shown in FIG. 1). The optional buffer 152 can be any suitable receptacle and/or container configured to contain and/or store a volume and/or quantity of the oxygen-enriched air stream 102a; and deliver the oxygen-enriched air stream 102a to the gas mixer 130 when needed. The air filter 120 can be any suitable gas/solid separation device configured to receive the ambient air stream 103 and remove impurities (e.g., particulates and the like). In some embodiments, the ambient air stream 103 can be passed through the air filter 120 and then directed, with the aid of the flow control device 164, to the optional buffer tank 152 for storage. As disclosed above, the optional buffer tank 152 can be any suitable receptacle and/or container configured to contain and/or store a volume and/or quantity of oxygen-enriched air 102a, ambient air stream 103 purified by the air filter 120, or a combination thereof.

The gas mixer 130 can be any suitable device configured to mix multiple gases. For example, in some embodiments the gas mixer 130 can be and/or include a plurality of mechanical and/or electrical mixing valves, flow controllers, manifolds of the like. The gas mixer 130 can be configured to receive and mix the feed gas supply 101, the oxygen-enriched air stream 102a, and/or the ambient air stream 103 according to preferred ratios and/or proportions, as further disclosed herein. FIG. 1 shows the gas mixer 130 can produce a mixture of the feed gas supply 101, the oxygen-enriched air stream 102a, and/or the ambient air stream 103, and then direct the produced mixture to the POX engine reactor 140 for further processing.

The POX engine reactor 140 can be any suitable internal combustion engine having at least one cylinder. The POX engine reactor 140 can be configured to receive the mixture of feed gas supply 101, the oxygen-enriched air stream 102a, and/or the ambient air stream 103, and facilitate conducting partial oxidation reactions to produce the synthesis gas 104 and power, as further disclosed herein. FIG. 1 shows the POX engine reactor 140 can include an outlet from which the synthesis gas 104 can be directed, via the optional flow control device 163, to a catalytic synthesis subsystem of a GTL system, such as, for example, a methanol synthesis subsystem. Alternatively, and/or optionally, in some embodiments the POX engine reactor 140 can be configured to direct the synthesis gas 104 to a buffer tank or a storage device (not shown in FIG. 1) for storing the synthesis gas 104 for further processing.

As disclosed above, the ASU 110 can be a device configured to separate and/or concentrate at least one component of bulk air (e.g., O₂, N₂, etc.), such that oxygenated air (e.g., an oxygen-enriched air stream 102a having 50 vol. % oxygen, 60 vol. % oxygen, 70 vol. % oxygen, 80 vol. % oxygen, 90 vol. % oxygen, 95 vol. % oxygen, 99 vol. % oxygen, and/or the like) can be produced. The balance (e.g., relatively concentrated N₂ and/or other air components) can be vented to atmosphere, stored for sale or use in other processes, and/or otherwise prevented from entering the feed gas reforming system 100.

ASUs can be broadly categorized into cryogenic distillation systems and non-cryogenic oxygen-enrichment technologies, such as pressure swing adsorption (PSA), vacuum pressure swing adsorption (VPSA), and membrane separation units.

Cryogenic ASUs utilize refrigeration and distillation of air to produce O₂, N₂, and, in some designs, argon (Ar) as separate product streams. Cryogenic ASU facilities operate at very large scales, typically hundreds to thousands of tons per day of oxygen production (equivalent to hundreds of thousands to millions of SCFH). Cryogenic ASUs routinely deliver oxygen streams with purities exceeding 99.5 vol. % O₂. However, the scale, capital cost, and operational complexity of cryogenic ASUs make them impractical for distributed or modular GTL systems at landfills, digesters, wastewater treatment facilities, or flare sites.

Despite the limitations of cryogenic ASUs disclosed above, in some embodiments the feed gas reforming system 100 can be configured to receive and process enriched air produced by a cryogenic ASU with the purpose of producing the synthesis gas 104. For example, in some embodiments the gas mixer 130 can be configured to directly receive a stream of oxygen-enriched air produced by an external (e.g., off-site) cryogenic ASU facility, wherein liquid oxygen from the facility is vaporized and supplied to the gas mixer 130 with the aid of the flow control device 162. The gas mixer 130 can receive the oxygen-enriched air stream 102a and mix it with the feed gas supply 101 to produce a suitable gas mixture that can be processed in the POX engine reactor 140 to produce the synthesis gas 104. Optionally, in some embodiments the oxygen-enriched air produced by the external cryogenic ASU facility can be stored as liquid oxygen in a storage tank and subsequently vaporized and delivered to the gas mixer 130 when needed, with the flow control device 162 regulating the delivery.

PSA and VPSA oxygen systems are more suitable for small- to intermediate-scale applications. PSA units are commercially available for capacities ranging from a few hundred standard cubic feet per hour (SCFH) up to ˜10,000 SCFH, whereas VPSA units generally operate at larger scales of several thousand SCFH up to several hundred thousand SCFH. Both PSA and VPSA units produce oxygen-enriched streams of about 85-95 vol. % O₂ (balance primarily N₂ and Ar) at pressures above ambient, typically on the order of ˜0.2-5.5 barg (≈3-80 psig), depending on the package configuration and any integrated boosters. Unlike cryogenic ASUs, PSA, and/or VPSA systems do not produce ultra-high-purity oxygen or argon as a separate product, but they provide cost-effective, modular oxygen supply solutions aligned with distributed GTL installations. Consequently, in some embodiments the ASU 110 can be and/or include PSA and/or VPSA oxygen-enrichment systems. These systems provide oxygen purities sufficient to support rich-burn operation of the POX engine reactor 140 (e.g., at an equivalence ratio >2) while avoiding the scale, cost, and complexity associated with cryogenic ASUS.

It is worth noting that PSA and VPSA oxygen-enrichment systems inherently require pressurization of the feed air as a fundamental part of the separation cycle. In PSA units, the incoming air stream is typically compressed to several bar (e.g., 20-80 psig) and passed through a vessel containing an adsorbent bed (e.g., a bed containing an adsorbent material such as zeolites, molecular sieves, activated carbon or the like) so that N₂ can be selectively adsorbed, after which the adsorbent beds are depressurized to regenerate.

VPSA systems operate with lower feed pressures (e.g., 3-15 psig) but require vacuum pumps to regenerate the adsorbent beds, in addition to a feed blower or low-pressure compressor. In both cases, compressor or blower work represents a significant additional power demand. The discharge pressure of the enriched air is dictated by the package design: when the PSA/VPSA unit is configured to deliver product oxygen at higher pressures (e.g., 3-80 psig), the outlet stream of the PSA/VPSA unit may be supplied directly to the POX engine reactor 140. When the unit delivers at only a few psig, a downstream booster compressor is required. Thus, while compression is always necessary for PSA/VPSA operation, higher discharge designs can reduce or eliminate the need for a separate additional booster stage downstream. Further details on the thermodynamic properties of ambient air and oxygen-enriched air at the inlet of the POX engine reactor 140 are summarized in Table 1.

TABLE 1
Thermodynamic properties of ambient air and oxygen-enriched
air at POX engine reactor 140 intake (298K, 1 bar).

| | Ambient air | Enriched air |
|---|---|---|
| Property | (21% O₂) | (93% O₂) |
| Mean molar mass (g/mol) | ~28.9 | ~31.7 |
| Gas constant R (J/kg K) | ~288 | ~262 |
| Specific Heat Cp (kJ/kg K) | ~1.01 | ~0.93 |
| Heat capacity ratio γ | ~1.40 | ~1.40 |
| Density (kg/m³) | ~1.16 | ~1.28 |
| Molar entropy (J/mol K) | ~199 | ~206 |
| Specific entropy (kJ/kg K) | ~6.9 | ~6.5 |

When oxygen-enriched streams are considered at their actual discharge pressures from PSA or VPSA units, additional pressure-dependent effects appear. Higher discharge pressures reduce entropy and increase density, which directly influence compressor work, intercooling requirements, and power allocation. Table 2 shows representative values at 298 K for a 93 vol. % O₂ stream at 30 psig (˜3.1 bar abs) and 60 psig (˜5.2 bar abs).

TABLE 2
Thermodynamic properties of enriched air
at ASU discharge pressures (93% O₂, 298K)

| | 30 psig | 60 psig |
|---|---|---|
| Property | (~3.1 bar abs) | (~5.2 bar abs) |
| Mean molar mass (g/mol) | ~31.7 | ~31.7 |
| Gas constant R (J/kg K) | ~262 | ~262 |
| Specific Heat Cp (kJ/kg K) | ~0.93 | ~0.93 |
| Heat capacity ratio γ | ~1.40 | ~1.40 |
| Density (kg/m³) | ~3.9 | ~6.6 |
| Molar entropy (J/mol K) | ~197 | ~192 |
| Specific entropy (kJ/kg K) | ~6.2 | ~6.0 |

The results summarized in table 1 and 2 show that oxygen-enriched air and ambient air differ in entropy, enthalpy, density, and heat capacity. Such differences influence POX reactor performance, including compression behavior and adiabatic temperature rise, and may be exploited in control strategies that explicitly distinguish between air-breathing operation and oxygen-enriched operation. In certain embodiments, the system includes additional flow control devices and feedback loops for each oxidizer stream, enabling the controller to regulate and balance the contribution of ambient air and oxygen-enriched air supplied to the POX engine reactor 140.

Alternatively, in some embodiments, the ASU 110 can be and/or include membrane-based oxygen enrichment units. Membrane oxygen-enrichment units are typically deployed at smaller scales, on the order of tens to a few thousand SCFH, and are capable of providing oxygen concentrations in the range of ˜30-50 vol. % O₂. Their discharge pressures are generally modest (e.g., ˜0.1-1 barg, ≈2-15 psig), reflecting the low-pressure driving force across the membrane. Although these enrichment levels are lower than those currently achieved by adsorption or cryogenic systems, advances in membrane materials and system integration may, over the lifetime of this patent, enable their application in higher-equivalence-ratio reforming processes.

The flow control devices 161-164 can be, for example, mechanical and/or electromechanical actuators (e.g., valves, mass flow controllers, injectors, compressors, blowers, regulators etc.) that can controllably vary flow rates of the feed gas supply 101, the ambient air stream 103, oxygen-enriched air produced by the ASU 110, and/or the synthesis gas 104, in response to a control signal, as described further herein. As disclosed above, The flow control device 161 can be in fluid communication with the feed gas supply 101 and the POX engine reactor 140 (e.g., via an engine intake manifold) and can be configured to regulate a flow of the feed gas supply 101 to the POX engine reactor 140. The flow control device 162 can be in fluid communication with the ASU 110 and the buffer tank 152. The flow control device 162 can be configured to regulate a flow of oxygen-enriched air from the ASU 110 to the buffer tank 152. The optional flow control device 163 can be configured to regulate the flow of synthesis gas and/or syngas 104 that is output from the POX engine reactor 140. In some embodiments, the optional flow control device 163 can be configured to control back pressure on the POX engine reactor 140. The flow control device 164 can be in fluid communication with the ambient air stream 103 and the air buffer tank 152, as shown in FIG. 1. In some embodiments, the flow control device 164 can be configured to regulate a flow of the ambient air steam 103 to the buffer tank 152, after the ambient air stream 103 is passed through the air filter 120. As disclosed above, in some embodiments the buffer tank 152 can be used for mixing ambient air (e.g., the ambient air stream 103) with oxygen-enriched air from the ASU 110 and for damping pressure fluctuations caused by engine pulses on the airflow through the flow control device 164. The buffer tank 152 is optional and may not be required in all configurations. In some embodiments, the flow control devices 161, 162, and 164 can be configured to regulate the flow rate of the feed gas supply 104, the oxygen-enriched air stream 102a, and the ambient air stream 103 to adjust the supply pressure of their respective streams such that the pressure at the gas mixer 130 (or at the POX engine reactor 140) is substantially uniform. The pressure at the inlet of the gas mixer 130 and/or the POX engine reactor 140 may be controlled to any value between sub-ambient and above-ambient depending on the operating conditions of the feed gas reforming system 100. For example, during start-up conditions the pressure can be below ambient pressure (e.g., sub-ambient), during steady state operation the pressure can be approximately ambient pressure, and under certain conditions, the pressure can be above ambient pressure (e.g., above-ambient). The oxygen-enriched air stream 102a may initially be supplied at a pressure on the order of about 0.2-5.5 barg (≈3-80 psig), while the ambient air stream 103 is typically near ambient pressure before regulation.

As disclosed above, the feed gas reforming system 100 can have three inlet streams and one outlet stream. The first inlet stream can be and/or include the feed gas supply 101. The feed gas supply 101 can be a stream obtained from, for example, a feed gas conditioning subsystem that is coupled to the POX engine reactor 140. The feed gas supply 101 can be directed to the POX engine reactor 140 with the aid of the flow control device 161. The feed gas supply 101 can include gaseous hydrocarbons conditioned to, for example, control temperature, water content, and/or the concentration of other impurities. The second inlet stream can be and/or include oxygen-enriched air stream 102a produced from the ambient air stream 102 via the ASU 110. As disclosed above, the oxygen-enriched air stream 102a produced by the ASU 110 can be directed to the gas mixer 130 and then to the POX engine reactor 140 with the aid of the flow control device 162. The third inlet stream can be and/or include the ambient air stream 103. The ambient air stream 103 can be passed through the air filter 120 and the directed to the POX engine reactor 140 with the aid of the flow control device 164. The oxygen-enriched air stream produced by the ASU 110 can be combined with the ambient air stream 103 to form an oxidant stream. This combination can facilitate dilution of oxygen in the oxidant stream, which can be beneficial during a startup operation, a shutdown operation, and/or an emergency scenario, such as a runaway engine scenario, an engine overheat scenario, etc. In alternate embodiments, the ambient air stream 103 may be absent, and oxygen concentration can be controlled via the ASU 110.

In some implementations, during steady-state (or near steady-state) operation, the feed gas supply 101 and the oxygen-enriched air stream 102a from the ASU 110 can be the only two inlet streams directed to the POX engine reactor 140, and the ambient air stream 103 can be excluded (or substantially reduced) via the flow control device 164. The feed gas supply 101 and the oxygen-enriched air stream 102a from the ASU 110 can be premixed (in the gas mixer 130) before entering the POX engine reactor 140. In some embodiments, the feed gas supply 101 may be supplied to the POX engine reactor 140 at a pressure above ambient or at (or substantially near) ambient.

For embodiments in which the feed gas supply 101 is supplied at a pressure above ambient, both the feed gas supply 101 and the oxygen-enriched air stream 102a produced by the ASU 110 can be regulated by their respective flow control devices 161 and 162 so that the combined intake is delivered to the POX engine reactor 140 either (i) at or near ambient pressure or (ii) at a pressure above ambient to provide a boosted engine inlet.

For embodiments in which the feed gas supply 101 is supplied at ambient (or substantially near ambient) pressure, the oxygen-enriched air stream 102a produced by the ASU 110 can be regulated via the flow control device 162 so that the combined intake is delivered near ambient. Alternatively, the feed gas can be boosted via flow control device 161 and the oxygen-enriched air regulated via flow control device 162 so that the combined intake is delivered above ambient pressure to achieve a boosted engine inlet.

In some embodiments, operating in boosted configurations (i.e., with the intake mixture above ambient pressure) can increase throughput and/or performance of the POX engine reactor 140.

In some embodiments not illustrated in FIG. 1, the feed gas supply 101 may be supplied at pressure or after compression and introduced directly into the POX engine reactor 140. In such embodiments, the flow control device 161 can be configured as a direct injector, enabling complete or partial direct injection of the feed gas supply 101 into the reactor chamber of the POX engine 140. In these embodiments, the oxidizer streams continue to enter through the engine intake, while the feed gas supply 101 is separately injected to control the mixture and combustion characteristics within the POX engine reactor 140.

The synthesis gas 104 can be and/or include reformed gas (e.g., syngas) output from the POX engine reactor 140. In some embodiments, the synthesis gas 104 can include including H₂, CO, H₂O (water vapor), N₂, CO₂, Ar, CH₄ and O₂. In some embodiments, the synthesis gas 104 can include H₂ at a concentration greater than at least 20 vol. % 30 vol. %, 40 vol. %, or 50 vol. %. In some embodiments, the synthesis gas 104 can include inert gases at a concentration of no more than about 50 vol. %, 40 vol. %, 30 vol. %, 20 vol. %, or 10 vol. %. In some embodiments, the optional flow control device 163 can be a valve that may be controlled to adjust a flow rate of the synthesis gas 104 and/or to increase a POX engine reactor 140 exhaust pressure. This increased pressure can reduce compression work performed by a compressor (e.g., reduce the number of compression stages) that provides the synthesis gas 104 to a downstream consumer system, processing system, etc. Consequently, both capital expenditure (CAPEX) and operating expenses (OPEX) associated with the compressor can be reduced. Moreover, increased exhaust pressure can leave heavy residuals in the POX engine reactor 140 and/or cause backflow of produced syngas into the intake of the POX engine reactor 140, such that the heavy residuals and/or the produced syngas mixes with the fresh inlet mixture from the feed gas supply 101, the oxygen enriched air stream produced by the ASU 110, and/or the ambient air stream 103. As a result, oxidation can be improved, which can permit the POX engine reactor 140 to operate at a higher equivalence ratio, as further described herein.

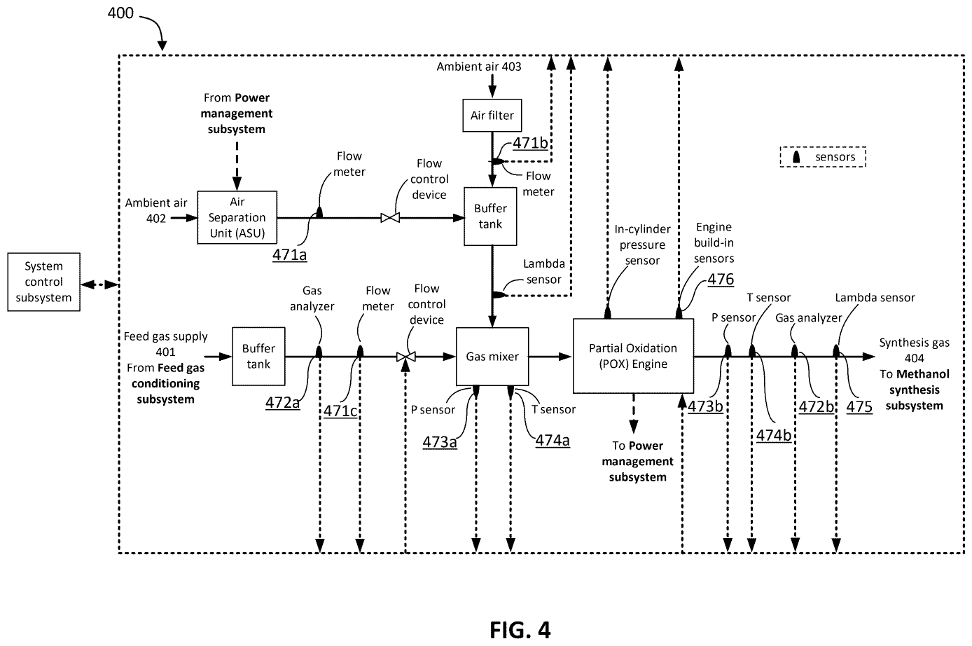

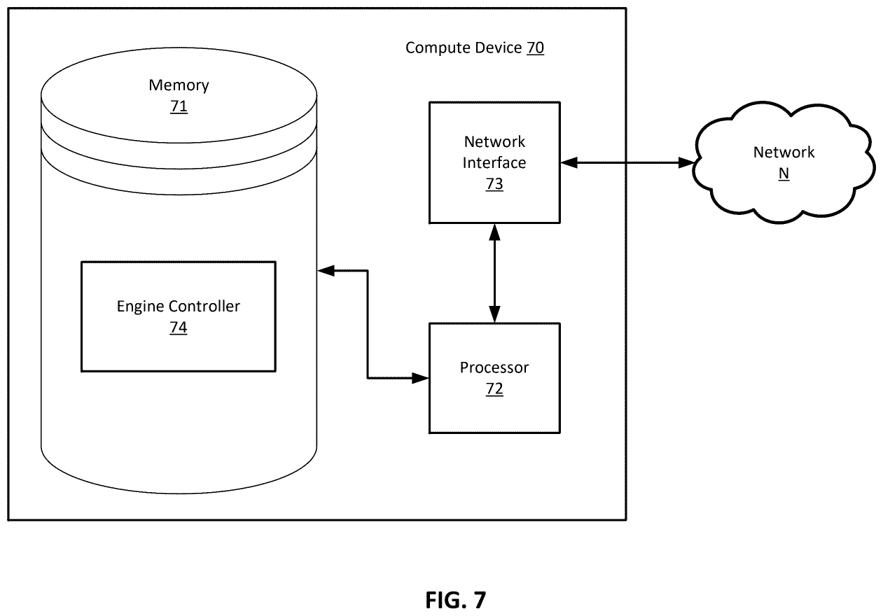

As described herein (e.g., at least in relation to FIGS. 4-7) the flow control devices can be controlled (e.g., via a processor that is functionally and/or structurally similar to the processor 72 of FIG. 7, and based on instructions that are stored in a memory that is functionally and/or structurally similar to the memory 71 of FIG. 7, described herein) to result in an equivalence ratio that can cause the synthesis gas 104 produced by the POX engine reactor 140 to have a desired quality. A desired synthesis gas 104 quality can have, for example, dry H₂/CO ratio >1.0 with a stoichiometric number (SN) greater than 0.5 and dry N₂<20 vol. %. SN number is defined as [H₂—CO₂]/[CO+CO₂]. For example, in some embodiments, the synthesis gas 104 can be characterized by a H₂/CO ratio of at least about 1.0, 1.2, 1.4, or 1.6. It is worth noting that the highest theoretical H₂/CO ratio that can be achieved when producing synthesis gas via partial oxidation reactions of any suitable hydrocarbon is 2.0. This H₂/CO ratio of 2.0 can be achieved (at least theoretically) during partial oxidation reforming reactions with methane gas. For all other hydrocarbons, reforming via partial oxidation reactions can produce a synthesis gas with a H₂/CO ratio that is less than 2.0. However, in some instances steam can be added to the hydrocarbons with the purpose of enabling autothermal reforming (ATR) reactions that can facilitate achieving H₂/CO ratios larger than 2.0. The POX engine reactor 140 disclosed herein is configured to produce (via partial oxidation reactions) the synthesis gas 104 with a H₂/CO ration between 1.0 and 2.0 and a SN greater than 0.5.

As disclosed above, The POX engine reactor 140 can be any suitable internal combustion engine having at least one cylinder. In some embodiments, the POX engine reactor 140) can include at least one reactor chamber (e.g., a cylinder) fluidically coupled and/or connected to a plurality of inlet streams. In some embodiments, the plurality of inlets stream can include a first stream configured to deliver and/or direct a reactant and/or a feed gas supply similar to and/or the same as the feed gas supply 101 disclosed above. In some embodiments, the plurality of inlets stream can include one or more oxidizer streams including an oxygen-enriched air stream produced by the ASU 110, similar to and/or the same as the oxygen enriched air stream 102a, 202a, 302a and/or 302b shown in FIGS. 1-3). In some embodiments, the plurality of inlets stream can include one or more oxidizer streams including an ambient air stream, similar to and/or the same as the ambient air stream 103-303 shown in FIGS. 1-3). In some embodiments, the plurality of inlet streams can be configured to supply variable relative contributions of the oxygen-enriched air stream and the ambient air stream such that a combined oxidizer stream (e.g., a stream produced after combining the oxygen-enriched air stream and the ambient air stream) has a variable oxygen concentration during operation of the POX engine reactor 140. In use, the POX engine reactor 140 can receive the plurality of inlets stream and facilitate initiating and/or conducting one or more chemical reaction(s) to produce the synthesis gas 104, along with mechanical power, as further disclosed herein. In some embodiments, the one or more chemical reaction(s) can be and/or include partial oxidation (POX) reactions. As disclosed above, in some embodiments the POX engine reactor 140 can facilitate conducting POX reactions to produce the synthesis gas 104 and power. In some embodiments, the power (or at least a portion of the power) produced by the POX engine reactor 140 can be used to power one or more components of the feed gas reforming system 100 such as, for example, the ASU 110. In some embodiments the power (or at least a portion of the power) produced by the POX engine reactor 140 can be directed to a power management subsystem, as shown in FIG. 1. In some embodiments, the power management subsystem can be similar to and/or the same as the power management component 3 of the GTL system 9000, which is further disclosed herein with reference to FIG. 10.

In some embodiments, the POX engine reactor 140 can be and/or include a conventional engine operating on a combustion cycle. In some embodiments, the POX engine reactor 140 can be an internal combustion engine including, for example, a spark-ignition engine, a compression-ignition engine, a homogeneous charge compression-ignition (HCCI) engine, or combinations thereof. In some embodiments, the POX engine reactor 140 can be configured to operate at an exhaust pressure that is above ambient pressure (e.g., 1 atm and/or 1.013 bar). Elevated exhaust pressure reduces the compression required in downstream syngas compressors, thereby decreasing both capital cost and operating power consumption. Suitable exhaust pressures can range from about 0.1 bar gauge to about 2 bar gauge (≈1.1 to 3.0) absolute bar), or in some cases up to about 5 bar absolute depending on downstream process integration and engine design. Operating at such pressures provides a balance between syngas quality, engine performance, and overall system efficiency. Operation at elevated exhaust pressure may increase the potential for gas leakage across piston rings or valve seals of the POX engine reactor 140, leading to undesirable blow by into the POX engine reactor 140 crankcase. Blowby reduces overall synthesis gas 104 yield and may contaminate engine lubricants. Accordingly, some embodiments of the present disclosure can employ POX engine reactors 140 specifically designed to minimize blowby, such as engines with advanced piston ring sealing systems or labyrinth seals. In addition, the crankcase can be fitted with a conduit or venting system to remove gases that accumulate in the crankcase. In some implementations, such blowby gases are redirected to an intake manifold of the POX engine reactor 140 for re-oxidation and conversion, thereby improving mass balance closure and minimizing emissions. In addition to reducing downstream compression work, operation of the POX engine reactor 140 at elevated exhaust pressure can increase the concentration of residual exhaust gases that are retained and mixed with the incoming charge before partial oxidation. Because these residuals include hydrogen and carbon monoxide, their presence in the cylinder of the POX engine reactor 140 promotes faster reaction propagation, reduces ignition delay, and improves overall methane conversion during partial oxidation. The controlled recirculation of this hydrogen-rich exhaust fraction therefore enhances reaction stability at high equivalence ratios and contributes to improved synthesis gas 104 quality.

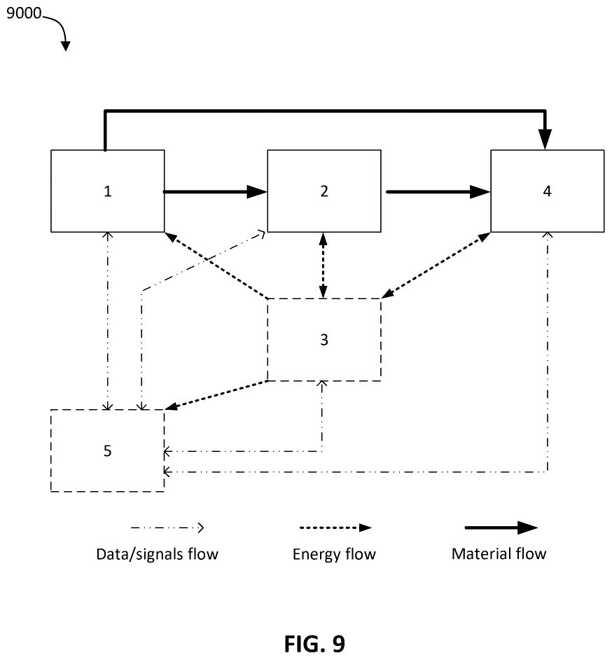

In some embodiments, the POX engine reactor 140 can be and/or include a reactor having a reciprocating motion (e.g., a reciprocating machine and/or engine) or constant-mass operation that performs partial oxidation or reforming reactions. In some embodiments, the POX engine reactor 140 can include a gas turbine or microturbine rather than an internal combustion engine. In such embodiments, the gas turbine and/or microturbine can be operated under fuel-rich conditions, with an oxidant stream that includes a controlled mixture of oxygen-enriched air from the ASU 110 and/or an ambient air stream 103, combined with the hydrocarbon-containing feed gas supply 101. Unlike reciprocating engines, turbine systems generally do not require spark timing control; instead, stability and conversion are managed through control of the oxidant composition, overall equivalence ratio, and fuel flow rate. The use of oxygen-enriched air oxidant enables the turbine combustor to achieve higher flame temperatures and higher hydrogen yields and methane conversion compared to operation on ambient air alone, while also reducing nitrogen dilution of the synthesis gas. In some embodiments, flow control devices can regulate the respective contributions of oxygen-enriched air, ambient air, and fuel, thereby controlling syngas composition and maintaining turbine operability. The exhaust stream from the turbine may be directed to downstream compression, conditioning, or catalytic synthesis subsystems, and the shaft power generated by the turbine can simultaneously be harvested to meet auxiliary power demands of an integrated GTL system, similar to and/or the same as the GTL system 9000 further disclosed with reference to FIG. 9.

In some embodiments, the POX engine reactor 140 can further include variable valve timing (VVT) capability on the intake and/or exhaust valves. By adjusting the valve events, the amount of residual gas retained in the cylinder after each cycle can be controlled. Unlike conventional stoichiometric engines, the residual gas in the POX engine reactor 140 operated with oxygen-enriched air contains a substantial fraction of hydrogen and carbon monoxide. Retaining a controlled fraction of this hot hydrogen-rich syngas improves flame propagation, reduces the risk of misfire, and enhances conversion of methane in subsequent cycles. Variable valve timing therefore provides an additional control lever, complementing oxidizer blending and spark timing, to stabilize operation at high equivalence ratios and to improve syngas quality.

In some embodiments, the feed gas reforming system 100 can include a plurality of inlet streams (e.g., the feed gas supply 101, the oxygen-enriched air stream 102a, and/or the ambient air stream 103) configured to deliver a reactant and one or more oxidizer streams to form a single, substantially uniform reaction zone within the engine reactor chamber(s) of the POX engine reactor 140. The POX engine reactor 140 can be configured to perform a single-stage reaction within the engine reactor chamber per engine cycle, in contrast to multi-stage or pilot-assisted combustion systems that rely on a separate pre-chamber. The reactant and oxidizer streams are mixed to establish a homogeneous mixture characterized by a single overall equivalence ratio, as further disclosed herein. The plurality of inlet streams and the reactor chamber geometry can be specifically designed to promote rapid and thorough mixing, thereby minimizing variations in the local fuel-to-oxidizer ratio. This configuration enables stable, controlled partial oxidation and consistent product composition within a single, integrated reaction zone during each engine cycle.

FIG. 2 shows a feed gas reforming system 200, according to an embodiment of the present disclosure. The feed gas reforming system 200 can include components that are structurally and/or functionally similar to the feed gas reforming system 100 described above with reference to FIG. 1. For example, as described above with the reference to the feed gas reforming system 100, the feed gas reforming system 200 can include an air separation unit (ASU) 210, an ambient air intake and/or air filter 220, a gas mixer 230, a POX engine reactor 240, and flow control devices 261, 262, 263, and 264. Optionally, in some embodiments the feed gas reforming system 200 can also include buffer tanks 251 and 252. The feed gas reforming system 200 can be configured to receive a feed gas supply 201, an ambient air stream 202, and an ambient air stream 203; and process the received streams to produce a synthesis gas 204. In some embodiments, portions, and/or aspects of the feed gas reforming system 200 can be similar to and/or substantially the same as portions and/or aspects of the feed gas reforming system 100 described above. Accordingly, such similar portions and/or aspects may not be described in further detail herein.

FIG. 2. shows the feed gas reforming system 200 includes a flow control device 261 configured to direct the feed gas supply 201 to the gas mixer 230 and then to an engine intake manifold of the POX engine reactor 240. Optionally, in some embodiments the feed gas supply 201 may be introduced directly into the POX engine reactor 240 (e.g., bypassing the gas mixer 230, not shown in FIG. 2). In such embodiments, the flow control device 261 can be configured as a direct injector, enabling complete or partially direct injection of the feed gas supply 201 into the reactor chamber of the POX engine reactor 240. The flow control device 262 of the feed gas reforming system 200 can be in fluid communication with the ASU 210 and the POX engine reactor 240, as shown in FIG. 2. The POX engine reactor 240) can be configured to produce the synthesis gas 204, which can be fed to any suitable gas storage or to a catalytic synthesis subsystem within the GTL system, such as a methanol synthesis subsystem, which may include or be integrated with a conditioning system, via the optional flow control device 263. In some embodiments, the feed gas reforming system 200 can also include a flow control device 264 disposed between the optional buffer tank 252 and the engine intake manifold of the POX engine reactor 240.

As disclosed above, the feed gas reforming system 200 can be configured to receive the feed gas supply 201, the ambient air stream 202, and the ambient air stream 203. These streams can be similar to those defined in relation to the feed gas reforming system 100 of FIG. 1, while having at least one different flow path. As shown in FIG. 2, the ASU 210 can receive the ambient air stream 202 and produce an oxygen-enriched air stream 202a that can flow directly (e.g., via the flow control device 262, which can be an injector and/or the like) into the POX engine 240 (e.g., via a manifold and/or direct injection into a cylinder(s) of the POX engine reactor 240), while the feed gas supply 201 and the ambient air stream 203 can be pre-mixed in the gas mixer 230 prior to entering the POX engine reactor 240. In this configuration, the oxygen-enriched air stream 202a can be introduced through one or more direct-injection ports or nozzles 262 positioned to create, in some embodiments, locally less-rich regions near the ignition source to facilitate easier and more stable ignition, or alternatively to achieve a substantially homogeneous mixture within the chamber through enhanced mixing. The combination of the premixed feed gas 201 and ambient air 203 with the directly injected oxygen-enriched air 202a forms a single-stage reaction zone within the reactor chamber 240). Despite possible localized variations in equivalence ratio, the overall reaction occurs within a single reactor chamber and constitutes a single, integrated reaction zone per engine cycle. The injection timing, direction, and flow rate of the oxygen-enriched air can be selected to regulate local reactivity, enhance partial-oxidation kinetics, and maintain a uniform overall equivalence ratio across the reaction zone.

FIG. 3 shows a feed gas reforming system 300, according to an embodiment of the present disclosure. The feed gas reforming system 300 can include components that are structurally and/or functionally similar to the feed gas reforming system 100 shown in FIG. 1 and/or the feed gas reforming system 200 shown in FIG. 2. For example, as described above with reference to the feed gas reforming system 100 and the feed gas reforming system 200, the feed gas reforming system 300 can include an air separation unit (ASU) 310, an ambient air intake and/or air filter 320, a gas mixer 330, a partial oxidation (POX) engine reactor 340, and flow control devices 361, 362, 364, and 365. Optionally, in some embodiments the feed gas reforming system 300 can also include buffer tanks 351 and 352. The feed gas reforming system 300 can be configured to receive a feed gas supply 301, an ambient air stream 302, and an ambient air stream 303; and process the received streams to produce a synthesis gas 304. In some embodiments, portions, and/or aspects of the feed gas reforming system 300 can be similar to and/or substantially the same as portions and/or aspects of the feed gas reforming system 100 and 200 described above. Accordingly, such similar portions and/or aspects may not be described in further detail herein. FIG. 3 shows the feed gas reforming system 300 includes a flow control device 361 configured to direct the feed gas supply 301 to the gas mixer 330) and then to an engine intake manifold of the POX engine reactor 340. Optionally, in some embodiments the feed gas supply 301 may be introduced directly into the POX engine reactor 340 (e.g., bypassing the gas mixer 330, not shown in FIG. 3). In such embodiments, the flow control device 361 can be configured as a direct injector, enabling complete or partial direct injection of the feed gas supply 301 into the reactor chamber of the POX engine reactor 340. The flow control device 362 of the feed gas reforming system 300 can be in fluid communication with an ASU 310 and the POX engine reactor 340, as shown in FIG. 3. Although not shown in FIG. 3, in some embodiments, a flow control device 363 can regulate flow of synthesis gas 304 that is output by the POX engine reactor 340. The feed gas reforming system 300 also includes (1) a flow control device 364 disposed between the air filter 320 and the optional buffer tank 352 and (2) a flow control device 365 disposed between the ASU 310 and the optional buffer tank. FIG. 3 shows a mixture of ambient air and oxygen-enriched air can be provided from the optional buffer tank 352 to the gas mixer 330 and then to the POX engine reactor 340. Alternatively, and/or additionally, an oxygen enriched air stream can be provided from the ASU 310 to the POX engine reactor 340 via the flow control device 362.

As disclosed above, the feed gas reforming system 300 can be configured to receive the feed gas supply 301, the ambient air stream 302 (which can be used to produce at the ASU 310 the oxygen enriched stream), and the ambient air stream 303. FIG. 3 shows the ASU 310 can receive the ambient air stream 302 and produce two oxygen-enriched air streams (a first oxygen-enriched air stream 302a and a second oxygen-enriched air stream 302b, as shown in FIG. 3). The first oxygen-enriched air stream 302a can flow directly to the POX engine reactor 340) (via the flow control device 362), while the feed gas supply 301 and the ambient air stream 303 can be pre-mixed in the gas mixer 330 or in an engine intake manifold of the POX engine reactor 340. The second oxygen-enriched air stream 302b can be combined with the ambient air stream 303 (after being passed through the air filter 320) and then pre-mixed with the feed gas supply 301 before entering the POX engine reactor 340. In some embodiments, the feed gas reforming system 300 is configured such that a smaller, metered portion of the oxygen-enriched air stream 302a is delivered directly to a pre-chamber of the POX engine reactor 340, while a larger portion of the oxygen-enriched air 302a is premixed with the ambient air stream 303 and the feed gas supply 301 upstream of the reactor chamber to form a premixed reactant stream. The pre-chamber is in fluid communication with the main chamber through a plurality of small passages, receives a locally less-fuel-rich mixture due to the concentrated admission of the smaller, direct-injected portion of 302a into the pre-chamber volume. Ignition is initiated in the pre-chamber, which, owing to its locally less-rich mixture and favorable turbulence, produces hot jets containing active radicals and partially oxidized products that discharge through the passages into the main chamber, thereby igniting the globally rich main-chamber mixture formed by the premixed feed gas 301, ambient air 303, and the larger portion of oxygen-enriched air 302a. The coupled interaction between the pre-chamber reactor and the main reactor establishes two distinct, yet functionally interdependent, reactors operating cooperatively within the system, while preserving the advantages of using two oxidizer streams (ambient air and oxygen-enriched air) for continuous control of oxygen concentration in the combined oxidizer stream before entering the engine reactor 340 and for precise control of the equivalence ratio. The injection timing and the split ratio of the oxygen-enriched air 302a between the pre-chamber reactor and the premix stream can be selected to stabilize ignition, extend the rich operating limit, and maintain a target syngas composition.

In at least some embodiments described herein at least in relation to FIGS. 1-3, a POX engine reactor can include a throttle body, which can be configured to control gas flow to the engine. This throttle body can operate in conjunction with the flow control devices previously described, offering further precision in regulating gas flow to optimize or improve engine performance.

In at least some embodiments described herein, at least in relation to FIGS. 1-3, the feed gas reforming system further comprises a positive crankcase ventilation (PCV) arrangement configured to redirect blowby gases from the crankcase to the intake of the POX engine reactor. Blowby, which includes leakage of high-pressure combustion gases, oxidizer, and unburned fuel past the piston rings into the crankcase, can be especially hazardous when the oxidizer stream has a high oxygen concentration, as such mixtures are highly ignitable. The PCV arrangement provides a controlled flow path for removing these gases from the crankcase and reintroducing them into the intake stream, thereby mitigating ignition risks in the crankcase while maintaining safe operation of the POX engine reactor.

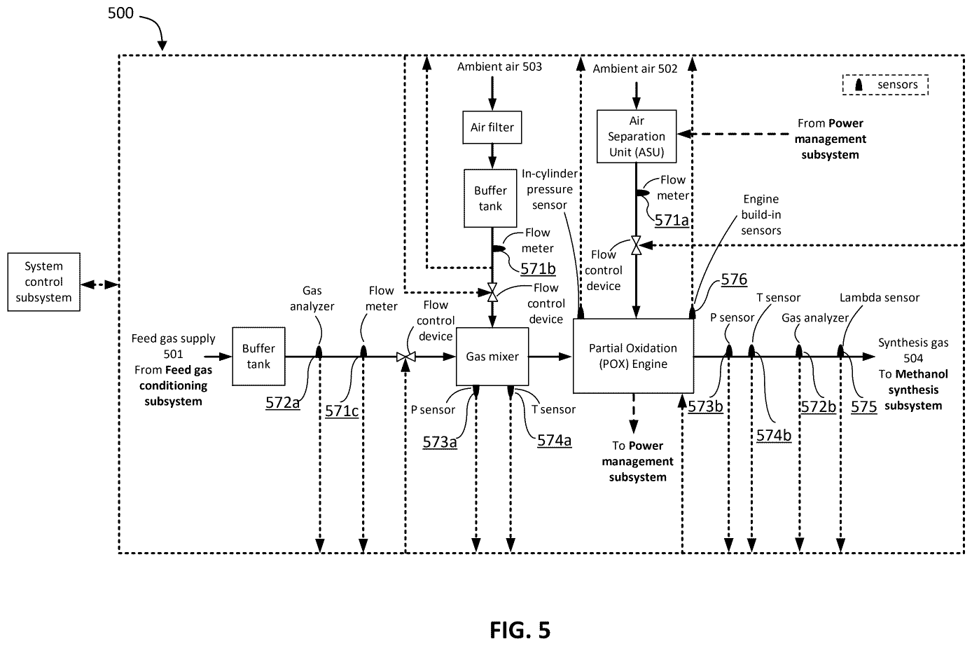

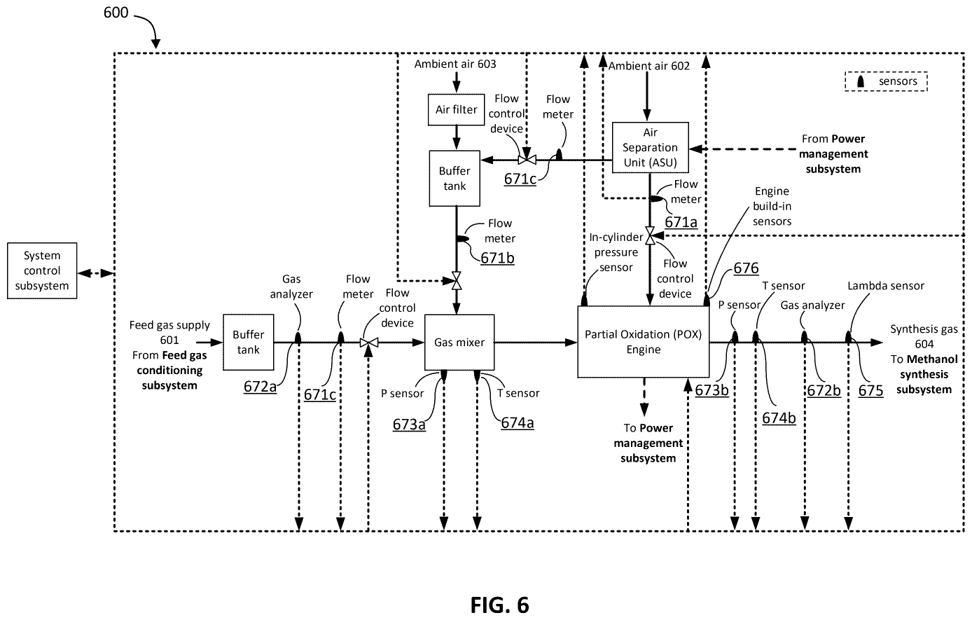

FIGS. 4-6 show, respectively, a plurality of control components 400, 500, and 600, according to some example embodiments. Dotted arrows depicted in FIGS. 4-6 can represent control signals, dashed arrows depicted in FIGS. 4-6 can represent power (e.g., electrical power) inputs and outputs, and solid arrows depicted in FIGS. 4-6 can represent material flow (e.g., gas flow, air flow, etc.). The control components 400 of FIG. 4 can be associated with a feed gas reforming system that is functionally and/or structurally similar to the feed gas reforming system 100 shown in FIG. 1. The control components 500 shown in FIG. 5 can be associated with a feed gas reforming system that is functionally and/or structurally similar to the feed gas reforming system 200 shown in FIG. 2. The control components 600 shown in FIG. 6 can be associated with a feed gas reforming system that is functionally and/or structurally similar to the feed gas reforming system 300 shown in FIG. 3. The control components 400, 500, and 600 can use equivalence ratio as a control parameter for engine operation and/or quality synthesis gas and/or syngas production. As used herein (e.g., in the context of an engine operating with oxygen-enriched air to produce syngas), equivalence ratio can be derived based on the following.

Feed gas hydrocarbons can be defined as, for example, a feed gas having a species with chemical formula CₐH_{b}O_{c} (where a, b, and c>=0). Fuel can be defined as, for example, a mixture of feed gas hydrocarbons (e.g., all feed gas hydrocarbons) with an average chemical formula CₙHₘOₚ. To illustrate, if the fuel includes, for example, methane (e.g., the fuel includes pure methane, where a=1, b=4, c=0), n can be 1, m can be 4, and p can be 0). If, for example, the fuel includes 4 parts methane and 1 part carbon dioxide (e.g., a=1, b=0), and c=2), n can be 1, m can be 16/5, and p can be 2/5. To further illustrate, if for example, the fuel includes 1 part each of methane, ethane (e.g., a=2, b=6, c=0), and diatomic nitrogen, the nitrogen can be ignored, and n can be 1, m can be 5, and p can be 0.

Complete combustion for a fuel CₙHₘOₚ can be described by equation 1:

$${C}_{n} {H}_{m} {O}_{p} + ( n + \frac{m}{4} - \frac{p}{2} ) {O}_{2} \to {n CO}_{2} + \frac{m}{2} {H}_{2} O \qquad ( 1 )$$

In some instances, despite not being shown in the above equation, other species can be present in the fuel or oxidizer stream. The fuel/oxygen ratio (F/O) on a molar basis can be defined as the molar flow rate of fuel (CₙHₘOₚ) divided by the molar flow rate of diatomic oxygen. The stoichiometric F/O (molar basis) can be defined (e.g., based on the above equation 1) as shown in equation 2:

$${( n + \frac{m}{4} - \frac{p}{2} )}^{- 1} \qquad ( 2 )$$

To illustrate, if, for example, the fuel includes pure methane, the stoichiometric F/O can be 1/2. Alternatively, if, for example, the fuel includes 4 parts methane, 1 part carbon dioxide, the stoichiometric F/O can be 5/8. To further illustrate, if the fuel includes 1 part each of methane, ethane and N₂, the N₂ can be ignored, and the stoichiometric F/O can be 4/9.

Fuel-oxygen equivalence ratio (referred to herein as φ, “phi”, and/or “equivalence ratio”) can be defined as the quotient of the actual fuel/oxygen ratio (F/O) to the stoichiometric F/O. Actual oxygen/fuel ratio (O/F) to the stoichiometric O/F ratio (referred to herein as λ and/or “lambda”) can be defined as the inverse of the fuel-oxygen equivalence ratio: λ=φ−1.

To control the POX engine reactor during steady-state operation, flow of ambient air into the POX engine reactor can be reduced or prevented, as ambient air can be introduced primarily during startup and/or shutdown operation, as described further herein. State variables that can govern engine control during steady-state operation can include equivalence ratio (φ, and/or phi) and engine power.

These state variables can be controlled indirectly by input variables, which can include, for example, flow rate of feed gas and flow rate of oxygen-enriched air from the ASU. The stability of combustion and/or quality of the produced syngas can be directly related to the equivalence ratio (φ, and/or phi). Thus, during steady-state operation (e.g., excluding startup, shutdown, an upsetting event, a disruption, and/or a scheduled change in operating condition), the engine can be operated at a fixed equivalence ratio (φ, and/or phi). In order to produce syngas having an acceptable quality and/or composition, φ can be between, for example, 2 and 4. Typical operating conditions can be, for example, φ=2.2 to 3.0. However, other operating conditions can be viable and/or preferable based on site-specific circumstances, such as the extent (if any) of feed gas pre-treatment. Engine power can be controlled based on system operation (e.g., beyond the POX engine reactor), as described herein.

The state of the system can be monitored by a collection of sensors included in the control components 400, 500, and/or 600 of FIGS. 4-6. Various combinations of sensors can be used to determine the equivalence ratio (φ, and/or phi) and/or engine power. In a first example sensor combination, flow meters 471c, 571c, and 671c can measure inlet (e.g., to the POX engine reactor) flow rates of the feed gas supply 401, 501, and 601, respectively. Flow meters 471a, 571a, and 671a can measure inlet flow rates of oxygen enriched air from the ASU (e.g., oxygen enriched air produced by the ASU from the ambient air supply 402, 502, and 602). Similarly, flow meters 471b, 571b, and 671b can measure inlet flow rates of ambient air supply 403, 503, and 603, respectively. Equivalence ratio (φ, and/or phi) can be directly calculated from stoichiometry (e.g., based on a predetermined feed gas supply composition and/or a measured feed gas supply composition, determined with the aid of a gas analyzer 472a, 572a, and/or 672a). Using this first example sensor combination, engine power can be calculated based on a predetermined relationship (e.g., via calibration) between total flow rate (e.g., the sum of the inlet flow rates for feed gas supply and oxygen-enriched air and ambient air), equivalence ratio (φ, and/or phi), and power.

In some embodiments, the feed gas reforming system can further include one or more in-cylinder pressure sensors operably coupled to the POX engine reactor. Such sensors may provide real-time pressure traces for each combustion cycle, which can be analyzed by the control system to detect combustion stability, knock, or misfire conditions. In-cylinder pressure feedback can be used to refine control of the equivalence ratio (φ, and/or phi), fuel injection timing, or oxidant flow, and to identify operating conditions that could lead to incomplete oxidation or methane slip in the produced syngas. By incorporating in-cylinder pressure as an additional feedback variable, the system can achieve tighter control over syngas quality and engine performance compared to using flow and exhaust composition measurements alone.

In a second example sensor combination, exhaust (e.g., from the POX engine reactor) gas composition and inlet (e.g., to the POX engine reactor) flow rate can be monitored. Exhaust gas (e.g., syngas) composition can be determined by direct gas analysis (e.g., using a gas analyzer 472b, 572b, and/or 672b) and/or indirect measurement using a lambda sensor 475, 575, and/or 675 and prior calibration. Exhaust gas composition can be directly related to the equivalence ratio (φ, and/or phi) based on prior calibration. More specifically, the ratio of H₂/CO and SN can be directly related to the equivalence ratio (φ, and/or phi) and can be monitored to ensure syngas quality. The inlet flow rate can be measured (a) directly as described in the first example sensor combination and/or (b) indirectly using (1) pressure sensors 473a, 573a, and/or 673a and temperature sensors 474a, 574a, and/or 674a, at the inlet, (2) tachometer measurement of engine speed (e.g., via the built-in engine sensors 476, 576, and/or 676, and/or (3) a known displacement volume. As in the first example sensor combination, engine power can be determined based on the total flow and the equivalence ratio (φ, and/or phi).

In a third example sensor combination, exhaust (e.g., from the POX engine reactor) gas composition and electrical power can be measured. The exhaust gas can be measured as described in relation to the second example sensor combination to determine the equivalence ratio (φ, and/or phi). The engine power can be determined based on power produced by an electrical generator that is operably coupled to the engine. Combinations of sensors other than those shown in FIGS. 4-6 and/or different sensor combinations than those shown in FIGS. 4-6 can be used to monitor the POX engine reactor.

Output variables of a feed gas reforming system can include, for example, produced syngas composition, in-cylinder pressure, and/or engine speed or power. Syngas composition can be related (e.g., proportional) to the equivalence ratio (φ, and/or phi), and engine speed and/or power can be related to total flow and equivalence ratio (φ, and/or phi).

A control scheme for operation of the POX engine reactor (e.g. during startup, transient, or steady-state conditions) can include, for example, closed-loop control to maintain the output variable(s) at a target value(s) while compensating for minor variations in conditions. For example, if generator load increases. The controller can detect this load increase manifested as decrease in speed or an increase of power demand and, in response, increase the total flow rate (while maintaining equivalence ratio (φ, and/or phi)) to increase the POX engine reactor power and restore the desired variable (e.g., 1800 rpm for a 4-pole generator at 60 Hz). As a further example, if the feed gas supply composition changes (e.g., slightly), the feed gas supply can have a different energy content and different stoichiometry. The differing energy content and stoichiometry can be detected by monitoring a change in the exhaust composition, which in turn can cause the control scheme (e.g., as executed via a processor) to cause flow rates to be adjusted accordingly (e.g., via a flow control devices). The change in energy content can also result in a change in output power, which can trigger a change in speed or power and a control response as described above.

To change engine power at constant equivalence ratio (φ, and/or phi), the flow rate of both streams (feed gas supply and the oxygen-enriched air and/or ambient air supply) can be increased or decreased by the same fraction (or a substantially equivalent fraction, such as within 10%, within 20%, etc.). Changing equivalence ratio (φ, and/or phi) at constant power can be more complex, as power can be a function of both equivalence ratio (φ, and/or phi) and total flow rate.

FIG. 7 shows a system block diagram of a compute device 70 included in a feed gas reforming system, according to an embodiment. The compute device 70 can be a hardware-based computing device, a multimedia device, or a cloud-based device such as, for example, a computer device, an electronic control unit (ECU), an electronic control module (ECM), an embedded controller, a server, a desktop compute device, a laptop, a smartphone, a tablet, a wearable device, a remote computing infrastructure, and/or the like. The compute device 70 includes a memory 71, a processor 72, and a network interface 73 operably coupled to a network N.

The processor 72 can be, for example, a hardware-based integrated circuit (IC), or any other suitable processing device configured to run and/or execute a set of instructions or code (e.g., stored in memory 71). For example, the processor 72 can be a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a graphics processing unit (GPU), a programmable logic controller (PLC), a remote cluster of one or more processors associated with a cloud-based computing infrastructure and/or the like. The processor 72 is operatively coupled to the memory 71 (described herein). In some embodiments, for example, the processor 72 can be coupled to the memory 71 through a system bus (for example, address bus, data bus, and/or control bus).

The memory 71 can be, for example, a random-access memory (RAM), a memory buffer, a hard drive, a read-only memory (ROM), an erasable programmable read-only memory (EPROM), and/or the like. The memory 71 can store, for example, one or more software modules and/or code that can include instructions to cause the processor 72 to perform one or more processes, functions, and/or the like. In some implementations, the memory 71 can be a portable memory (e.g., a flash drive, a portable hard disk, and/or the like) that can be operatively coupled to the processor 72. In some instances, the memory can be remotely operatively coupled with the compute device 70, for example, via the network interface 73. For example, a remote database server can be operatively coupled to the compute device 70.

The memory 71 can store various instructions associated with processes, algorithms, and/or data, including machine learning models, as described herein. Memory 71 can further include any non-transitory computer-readable storage medium for storing data and/or software that is executable by processor 72, and/or any other medium which may be used to store information that may be accessed by processor 72 to control the operation of the compute device 70. For example, the memory 71 can store software that is configured to receive measurement signals from a sensor(s) that is operably coupled to the compute device 71 via the network, as described below. The memory 71 can further store software that is configured to determine metrics (e.g., equivalence ratios (φ, and/or phi), engine power metrics (e.g., in kilowatts and/or the like), engine speed (e.g., in RPM and/or the like), etc.) and generate control signals to manipulate (e.g., via the network N) an ASU, engine speed of a POX engine reactor, and flow control devices.

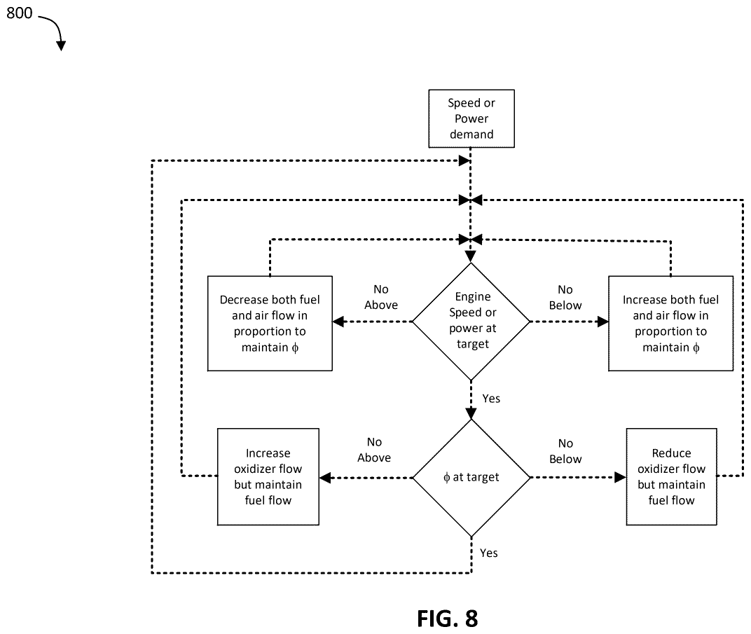

More specifically, the memory 71 can include an engine controller 74, which can include instructions that implement a POX engine reactor control strategy that is functionally similar to the control strategy 800 of FIG. 8 which is further described herein.

The network interface 73 can be configured to connect to the network N, which can include wired connections and/or wireless connections associated with various configurations and communication protocols, including, for example, short range communication protocols, Bluetooth®, Bluetooth® LE, the Internet, World Wide Web, intranets, virtual private networks, wide area networks, local networks, private networks using communication protocols proprietary to one or more companies, Ethernet, WiFi® and/or Hypertext Transfer Protocol (HTTP), cellular data networks, satellite networks, Control Area Network (CAN), Local Interconnect Network (LIN), free space optical networks and/or various combinations of the foregoing. Such communication can be facilitated by any device capable of transmitting data to and from other compute devices, such as a modem(s) and/or a wireless interface(s).

A plurality of sensors and a plurality of actuators can be operably coupled to the compute device 70 via the network interface 73 and the network N. The plurality of sensors can include, for example, flow meters, pressure sensors (e.g., that are configured to measure engine intake pressure, engine in-cylinder pressure, and/or engine exhaust pressure), temperature sensors (e.g., that are configured to measure engine intake temperature and/or engine exhaust temperature), lambda sensors (e.g., that are configured to measure air-fuel ration within a POX engine reactor), gas analyzers (e.g., that are configured to measure a composition of feed gas supply, a composition of a POX engine reactor inlet stream, and/or a composition of a POX engine reactor outlet stream (e.g., syngas), built-in engine sensors (e.g., engine tachometers, crankshaft position sensors, camshaft position sensors, etc.), and/or the like. The plurality of actuators can include, for example, an air separation unit (ASU), a POX engine reactor, and flow control devices.

In some instances, the compute device 70 can further include a display, an input device, and/or an output interface (not shown in FIG. 7). The display can be any display device by which the compute device 70 can output and/or display data (e.g., via a user interface). The input device can include a mouse, keyboard, touch screen, voice interface, and/or any other hand-held controller or device or interface via which a user may interact with the compute device 70. The output interface can include a bus, port, and/or other interfaces by which the compute device 70 may connect to and/or output data to other devices and/or peripherals. Alternatively or in addition, the compute device 70 can cause display of data and/or receive data via another compute that includes a display and/or input device.

The compute device 70 can be configured to control a POX engine reactor (e.g., that is functionally and/or structurally similar to the POX engine reactor 140 of FIG. 1, the POX engine reactor 240 of FIG. 2, and/or the POX engine reactor 340 of FIG. 3) to generate speed or power that can match demand of a Power Management Subsystem of a GTL system (as described in FIG. 10) while maintaining a target equivalence ratio (φ, and/or phi) while reforming syngas (e.g., as described herein at least in relation to FIG. 8). More specifically, the POX engine reactor can vary consumption of feed gas supply based on system demand. As described herein, in some implementations, the compute device 70 can store (e.g., in a memory that is functionally and/or structurally similar to the memory 71) a predefined map that can relate throttle position, engine RPM, exhaust oxygen content, engine intake pressure, and/or the like. The compute device 70 can use this predefined map to control for engine speed and/or equivalence ratio (φ, and/or phi). Furthermore, the compute device 70 can adjust oxidizer flow (e.g., via a flow control device) to cause a correction of the equivalence ratio (φ, and/or phi).

Multiple compute devices similar in structure and/or function to the compute device 70 can be operably coupled to the network to control different aspects of the feed gas reforming system. For example, a first compute device can include an engine control unit (ECU) that can regulate spark timing, while a second compute device can include a programmable logic controller (PLC) that can monitor system parameters and prevent gas flow to the POX engine reactor in the event of a system upset and/or anomaly. A third compute device can be configured to regulate fluid, thermal, and/or electrical loads between subsystems of the feed gas reforming system, as described further herein at least in relation to FIG. 9. The first, second, and/or third compute devices can be in communication with each other by exchanging data and/or control signals over the network, and/or the foregoing compute devices can operate independently (e.g., the ECU can regulate spark timing based on engine RPM and without having to communicate with another compute device). In some embodiments, some or all engine control functions can be completely or partially performed via mechanical and/or electro-mechanical mechanisms, such as timing chains, cam shafts, etc.

While some known internal combustion engines are configured to burn standardized fuels (e.g., gasoline, compressed natural gas (CNG), etc.), at least some systems and methods described herein can include a POX engine reactor that is configured to burn fuels from variable sources (e.g., landfill streams, waste streams, etc.) by employing both open-loop control (e.g., using a lookup table(s)) and closed-loop control to adapt to contemporaneous fuel conditions. Moreover, unlike some known internal combustion engines, which typically operate at stoichiometric (or near-stoichiometric) conditions, the POX engine reactors disclosed herein can operate at equivalence ratio (φ, and/or phi) values that exceed (e.g., are two times greater, three times greater, etc.) than an equivalence ratio (φ, and/or phi) value associated with stoichiometric or near-stoichiometric operation. As a result, the POX engine reactors can include sensors and/or instructions (e.g., that are executed via the compute device 70) to control oxidizer flow (e.g., by adjusting a ratio between oxygen-enriched air intake from an ASU (e.g., that is functionally and/or structurally similar to the ASU 110 of FIG. 1, the ASU 210 of FIG. 2, and/or the ASU 310 of FIG. 3) and ambient air intake (e.g., from an ambient air supply that is functionally and/or structurally similar to the ambient air supply and/or air filter 120 of FIG. 1, the ambient air supply and/or air filter 220 of FIG. 2, and/or the ambient air supply and/or air filter 320 of FIG. 3). The compute device 70 can be configured to control oxidizer flow while maintaining constant or substantially constant (e.g., within 5%, 10%, 20%, etc.) fuel flow to maintain a desired equivalence ratio (φ, and/or phi).

To illustrate, in response to a change in speed or power demand from the GTL system (e.g. a speed target or power demand from a Power Management Subsystem described in FIG. 9), the compute device 70 can be configured to adjust one or more flow control device(s) (e.g., that are functionally and/or structurally similar to the flow control devices 161-164 of FIG. 1, the flow control devices 261-264 of FIG. 2, and/or a flow control device 361-365 of FIG. 3) to change both supplied feed gas and supplied oxidizer in proportion to a mapped equivalence ratio (φ, and/or phi) value based on the predefined map. In response to an engine's exhaust composition deviating from a desired equivalence ratio (φ, and/or phi) (e.g., as measured by a gas analyzer, a lambda sensor, and/or an oxygen sensor, as described herein), the compute device 70 can cause oxidizer flow to be adjusted (e.g., via an ASU and/or a flow control device(s), as described herein).

A representation of example control logic for controlling both speed/power and equivalence ratio (φ, and/or phi) is shown in FIG. 8. In some embodiments, the control loop for engine speed and/or power is given higher priority than the control loop for equivalence ratio (φ, and/or phi), as shown in FIG. 8.

In some embodiments, the control strategy and/or logic for controlling a POX engine reactor similar to and/or substantially the same as the POX engine reactors 140-340, can include an engine start up procedure. Engine start up can be initiated under near-stoichiometric conditions using ambient air (e.g., ambient air stream 103-303) or a blend of ambient air and oxygen-enriched air (e.g., oxygen-enriched air stream 102a, 202a, 302a and/or 302b) as the oxidizer. At startup, the intake pressure may be sub-ambient or approximately ambient, and the total flow rate can be set to achieve a target engine speed and stable ignition. Stoichiometry (equivalence ratio φ≈1.0) can be established through open-loop control and optionally refined by using feedback from sensors that monitor exhaust composition or reactor (e.g., POX engine reactor 140-340) performance.

As the reactor stabilizes, the controller (e.g., engine controller 74) can gradually increase the equivalence ratio (φ, and/or phi) by adjusting the relative contributions of the ambient air stream and the oxygen-enriched air stream. The flow of ambient air can be reduced while the flow of oxygen-enriched air is proportionally increased to raise the effective oxidizer oxygen concentration and equivalence ratio (φ, and/or phi) thereby promoting partial oxidation reforming conditions. The controller can receive input from one or more sensors, such as flow, pressure, temperature, lambda, or gas composition sensors, and use this data to dynamically regulate the blending ratio and maintain stable combustion characteristics within the reactor.

During this transient phase, the intake pressure can also be increased from sub-ambient to the desired steady-state pressure as the target equivalence ratio (φ, and/or phi) is approached. The controller can coordinate oxidizer blending, feed gas (e.g., feed gas supply 101-301) flow; and intake pressure to maintain a desired operating condition. Sensor feedback from the intake manifold, reactor chamber, and exhaust stream (lambda and/or gas composition sensors) can be used to refine the control response, ensuring the desired pressure, temperature, and equivalence ratio (φ, and/or phi) trajectory are achieved without instability. The operating condition can be characterized by increasing equivalence ratio (φ, and/or phi) from near 1.0 to a target range of about 2.2-3.0, depending on feed composition and desired syngas characteristics.

When the target equivalence ratio (φ, and/or phi) intake pressure, and reactor temperature are achieved, steady-state operation is established. The controller can maintain the desired synthesis gas quality (e.g., synthesis gas 104-304 target H₂/CO ratio and stoichiometric number) through closed-loop adjustments of the oxidizer streams and feed gas flow rate. Data from one or more sensors monitoring exhaust composition and/or oxygen content, such as a lambda sensor, can be continuously processed to detect transient variations in feed gas composition or operating conditions, allowing the controller to automatically compensate and maintain stable, controlled partial-oxidation operation within the reactor.

Ambient air can be introduced to the POX engine reactor (e.g., at least one of the POX engines reactors 140-340 shown in FIGS. 1-3) during a transient operation such as startup operation, a shutdown operation, and/or an emergency scenario. For example, during startup, the POX engine reactor may be started under near-stoichiometric conditions with air or under partial oxidation at a low equivalence ratio (φ, and/or phi) using a lower-oxygen oxidizer than the oxygen-enriched air provided by the ASU (e.g., a mixture of ambient air and oxygen-enriched air). Since the oxygen-enriched air produced by the ASU is delivered at a fixed concentration, the effective oxidizer concentration can be varied by blending the oxygen-enriched air produced by the ASU with ambient air. As the engine transitions, the equivalence ratio (φ, and/or phi) is steadily increased toward a target value by reducing the flow of ambient air and increasing the flow of oxygen-enriched air. The higher oxygen concentration enables operation at higher equivalence ratios (φ, and/or phi) by displacing inert N₂ with reactive oxygen. During this transition, the intake pressure may start below the steady-state operating condition and be gradually increased toward the steady-state pressure as the φ approaches its target value. In some embodiments, the steady-state operating condition may correspond to an intake pressure that is below ambient, approximately ambient, or above ambient, depending on the system configuration and operating requirements. Steady-state operation is defined as the condition where the target speed/power and equivalence ratio (φ, and/or phi) has been reached and maintained, producing a syngas of the desired quality for downstream processing.

At a constant equivalence ratio (φ, and/or phi), flame temperature and speed are increased as the concentration of oxygen in the oxidizer is increased. Likewise, at a constant oxygen concentration, flame speed and temperature will decrease as the equivalence ratio (0, and/or phi) is changed further from a value of 1.0. In an engine, the spark plug is fired before the piston reaches its highest point (referred to as top dead center or TDC) to allow for the propagation time of the flame. To widen the window of stable operation (e.g., ensure that the maximum pressure occurs at the right time in the engine cycle that the engine's coefficient of variation remains within a target range), spark timing can be used as an adjustable parameter. For example, if the peak pressure occurs too early (e.g., due to oxygen content being too high for the given equivalence ratio (φ, and/or phi)), spark timing can be set later to compensate for the faster flame speed. Likewise, if the peak pressure occurs too late (e.g., due to oxygen content being too low for the given equivalence ratio (φ, and/or phi)), spark timing can be set earlier to compensate for the slower flame speed. This additional control can widen the range of stable operation during both startup and steady state.

During a shutdown and/or emergency operation, to halt combustion, spark plugs within the POX engine reactors can be disabled. Then, the enriched-oxygen stream can be closed (e.g., via an ASU, such as the ASU(s) 110-310 and/or a flow control device, such as the flow control device(s) 162-362), and the ambient air supply can be opened via a flow control device (e.g., the flow control device(s) 164-364). In at least some instances, it can be safer to stop (or substantially reduce) the enriched-oxygen stream before stopping the feed gas supply; otherwise, the equivalence ratio (φ, and/or phi) will drop and pass through a value of 1.0 in an oxygen rich stream, which can result in an extremely ignitable mixture that can potential auto-ignite off the hot components of the engine. In some instances, it is safer to shut the flow control devices 162-362 first while opening the flow control devices 164-364. If fuel flow is kept constant (e.g., by keeping the flow control devices 161-361 unchanged), the equivalence ratio (φ, and/or phi) will increase beyond the rich limit, producing a non-combustible mixture. Then, once the oxidizer stream oxygen content has been reduced to near ambient air (e.g., the buffer tank 152-352 has been purged of excess oxygen), the fuel flow can be shut off (using the flow control devices 161-361). Now, when the equivalence ratio (φ, and/or phi) passes through 1.0, it happens in a much lower oxygen content and the mixture is less likely to be auto-ignited. Enabling the ambient air stream 103 can prevent a vacuum from forming within the POX engine reactor and/or can prevent damage to the POX engine reactor. An exhaust purge at the POX engine reactor outlet can also be opened (e.g., to a flare), which can prevent contamination of a downstream process and/or can dissipate continuous flow of gas through the POX engine reactor.

During upset operation, the ambient air supply flowing with the aid of the flow control device 164-364 may be replaced with a flow of an inert gas such as nitrogen. This will further reduce the risk of un-intentional ignition during a system shutdown.

After performing the above, the compute device (e.g., the compute device 70 of FIG. 7, described herein) can be configured to shut-off (e.g., via the flow control device 161-361) feed gas supply to the POX engine reactor and/or redirect the feed gas supply to, for example, a flare. At this point in the operation, passing through an equivalence ratio (φ, and/or phi) equal to 1.0 can have reduced significance (e.g., as compared to the scenario described above) because engine combustion can no longer be oxy-fired (or substantially oxy-fired). The POX engine can then be permitted to spin down with ambient airflow and/or with additional braking.

The shutdown described above will result in a sudden drop in power produced by the POX engine reactor. In some cases, it may be desirable to gradually reduce the POX engine reactor power to ensure a less intense upset to the electrical system. In this case, the reverse of the start-up sequence can be followed. Specifically, ambient air can slowly be introduced (via the flow control devices 164-364) to displace the flow from the ASU (ASU 110-310) as the equivalence ratio (φ, and/or phi) is slowly decreased. This procedure can be performed at a rate that avoids sudden upsets to the electrical grid.

As described herein, the equivalence ratio (φ, and/or phi) can be a governing control parameter for at least some embodiments of a gas reforming system. Some known methods of determining equivalence ratio (φ, and/or phi), however, can be difficult to perform in real-time (or near real-time). For example, some known methods use sensitive gas analysis instrumentation such as Fourier Transform Infra-Red Spectroscopy (FTIR), for measuring inlet or exhaust gas composition. However, FTIR instrumentation can have a significant lag, and thus FTIR instrumentation may be unsuitable for field use. Consequently, There is a need for a method for determining equivalence ratio (φ, and/or phi) in engine exhaust that can be (1) performed quickly to ensure accurate POX engine control and produce feed gas of sufficient quality, (2) robustly to account for variable feed gas compositions and (3) that can supplement flow measurements at the POX engine intake. While the equivalence ratio (φ, and/or phi) in some instances can be determined based only on flow measured at engine intakes, in other instances, a same (or substantially similar) equivalence ratio (φ, and/or phi) value can result in different exhaust compositions, which can depend on equilibrium within the POX engine.

There are several scenarios where inlet flow-based measurements of equivalence ratio (φ, and/or phi) are inadequate. As one example, in some embodiments in which the feed gas reforming system includes an optional buffer tank (e.g., the buffer tank 151-351, and/or the buffer tank 152-352) can result in a lag between equivalence ratio (φ, and/or phi) determined based on inlet flows and the actual equivalence ratio (φ, and/or phi) present in the engine cylinder. For rapid cycle-to-cycle control excepting flow control (e.g., spark-timing adjustment as described above), this lag may be significant. In the event of feed gas supply composition drift, this will not be captured in the equivalence ratio (φ, and/or phi) calculation from inlet flows and detecting it based on upstream gas analysis may be too slow.

To determine equivalence ratio (φ, and/or phi), a feed gas reforming system (e.g., as described herein) can include an optional wideband O₂ sensor. This sensor can be configured to detect oxygen composition in exhaust, and this amount of oxygen can be related to an equivalence ratio (φ, and/or phi). This sensor can also be configured to be sensitive to other species (e.g., exhaust components), such as carbon monoxide (CO) and/or other species that can be oxidized. The optional wideband O₂ sensor can be configured to have a different sensitivity to each of the species (e.g., hydrogen (H₂), CO, etc.) that can be present in the combustion exhaust of the POX engine reactor. In some implementations, the optional wideband O₂ sensor can produce a single output current measurement, which can be insufficient for directly distinguishing between species within the exhaust. The signal can still be used to determine mole fractions associated with the exhaust. For example, in some instances mole fractions associated with the exhaust can be determined based on the optional wideband O₂ sensor output and linear system analysis.

A typical wideband O₂ sensor typically consist of a Nernst cell which results in a voltage dependent on the difference in oxygen concentration between the sample gas and a reference gas. If a reducing species such as H₂ or CO is present in the sample gas, the wideband O₂ sensor will produce a response similar to that of decreasing oxygen concentration in the sample gas, as it causes electrons to flow counter to the direction that an oxidative species would. In some instances this response is species dependent, and thus it may need to be calibrated.

While the oxygen sensor construction is the same as the oxygen sensor of a conventional vehicle, the conversion of the measurement into a species concentration is very different. In typical automotive applications, response to oxygen concentration alone is sufficient as the target equivalence ratio is near 1. Reducing species are present in small quantities and may show up as a “negative” oxygen concentration (depending on calibration) indicating rich combustion. For the POX engine reactors disclosed herein, measurement of those reducing species is of primary interest. Additionally, typical automotive sensors calculations have an implicit assumption of the concentration of oxygen in the oxidizer stream is that of ambient air which is not true in our case due to the use of an oxygen-enriched air stream. Our high oxygen concentration in the oxidizer means that we can produce a considerably higher concentration of reducing species for the same equivalence ratio (φ, and/or phi) as would be possible in air. It is also common for the measurement circuits of these sensors to “cap” the value that can be read. While the hardware is capable of measuring the conditions of our engine, conventional automotive measurement procedures and calibrations are inadequate and custom calibrations and calculations must be performed.

A simple model assumes linear dependence on each species and that the responses are linearly independent. In this example, the optional wideband O₂ sensor can measure an output y, which can be a linear function of the mole fraction of H₂ and CO, x_{H}_{₂} and x_{CO} respectively, as shown in equation 3 below:

$$y = {ax}_{{H}_{2}} + {bx}_{CO} \qquad ( 3 )$$

Supposing that the equilibrium temperature of the POX engine is known, (which can be a suitable assumption, as the equilibrium temperature is typically within a narrow range. It can also be related to the exhaust temperature, which is measured), the following ratio can be determined:

$$Z = \frac{{x}_{{H}_{2}} {x}_{{CO}_{2}}}{{x}_{CO} {x}_{{H}_{2} O}} \qquad ( 4 )$$

The actual mole fraction of all product species can then be determined by solving for the coefficients φ, a, b, c, d, e in the equation below. This can be done using the equations for y and z above as well as 4 atomic balance equations for C, O, N, H to yield a system of 6 equations and 6 unknowns (x_{O}_{₂} is assumed to be known). A similar procedure applies for any fuel with known composition CₙHₘOₚ as defined above with reference to equations (1) and (2) above:

$$ϕ {CH}_{4} + 2 ( {O}_{2} + \frac{1 - {x}_{{O}_{2}}}{{x}_{{O}_{2}}} {N}_{2} ) \to a CO + b {CO}_{2} + {c H}_{2} + {d H}_{2} O + {eN}_{2} \qquad ( 5 )$$

The synthesis gas produced by the POX engine reactor (e.g., synthesis gas 104-304) can be provided to a downstream system that uses syngas and/or chemical conversion to produce, for example, methanol, higher alcohols, hydrocarbons, ammonia and/or other chemical products.

In at least some embodiments, the control system is further configured to prevent conditions that would result in engine misfire and substantial methane slip in the syngas. For example, the processor (e.g., processor 72) may continuously monitor exhaust gas composition and equivalence ratio (φ, and/or phi) to ensure stable partial oxidation. If the equivalence ratio (φ, and/or phi) exceeds a predetermined limit or if incomplete conversion is detected (e.g., elevated methane concentration at the exhaust), the control system can adjust oxidant and fuel flows to restore stable operation. In some implementations, thresholds are selected such that unreacted methane in the producer gas remains below a predetermined concentration, thereby improving syngas quality, protecting downstream catalysts, and reducing greenhouse gas emissions. The concentration of the unconverted reactant in the exhaust gas should be less than 5%.

FIG. 9 shows a GTL system 9000 that includes a feed gas reforming system 2 substantially similar to and/or the same as the feed gas reforming systems 100-300 disclosed above with reference to FIGS. 1-3. The GTL system 9000 can further include: a methanol synthesis subsystem 4, which conditions syngas (e.g., synthesis gas produced by the feed gas reforming system 2) to adjust its pressure, temperature, and composition, reduce contaminants, and catalytically synthesize liquid products (e.g., methanol); a power management subsystem 3, which manages and distributes power supply within the GTL system 9000 and meets the power requirements of the GTL process; a feed gas conditioning subsystem 1, which pretreats raw feed gas to remove unwanted impurities and can optionally upgrade the hydrocarbon quality of the raw feed gas to produce a feed gas supply that can be directed to the feed gas reforming system 2; and a system control subsystem 5, which controls and coordinates operations between subsystems and provides system-level management. As described herein, the POX engine reactors (e.g., POS engine reactors 140-340) can be configured to convert a feed gas supply (e.g., methane, biogas, etc, the feed gas supply 101-301.) into syngas (e.g., a mixture of CO and H₂, synthesis gas 104-304) using an oxygen-enriched air stream (e.g., oxygen-enriched air stream 102a, 202a, 302a and/or 302b) from an air separation unit (ASU 110-310, as described herein). This syngas can subsequently be fed to the Methanol Synthesis Subsystem 4 to produce methanol as an example of a liquid product, which creates a first interaction.

In the GTL system 9000, the POX engine reactor can facilitate a plurality of interactions (e.g., integrations) with other subsystems. For example, a first interaction can occur with the power management subsystem 3, where the shaft power produced by the POX engine reactor during partial oxidation can be harvested, managed, and distributed to meet the system's power demands. A second interaction can occur with the system control subsystem 5, which monitors and coordinates the operation of the POX engine reactor with other subsystems at the system level, including adjustments in response to process changes. A third interaction can occur with the feed gas conditioning subsystem 1, where feed composition, flow rate, and impurity levels can be monitored and controlled to optimize POX engine reactor operation and syngas quality.

The drawings primarily are for illustrative purposes and are not intended to limit the scope of the subject matter described herein. The drawings are not necessarily to scale; in some instances, various aspects of the subject matter disclosed herein can be shown exaggerated or enlarged in the drawings to facilitate an understanding of different features. In the drawings, like reference characters generally refer to like features (e.g., functionally similar, and/or structurally similar elements).

The acts performed as part of a disclosed method(s) can be ordered in any suitable way. Accordingly, embodiments can be constructed in which processes or steps are executed in an order different than illustrated, which can include performing some steps or processes simultaneously, even though shown as sequential acts in illustrative embodiments. Put differently, it is to be understood that such features cannot necessarily be limited to a particular order of execution, but rather, any number of threads, processes, services, servers, and/or the like that can execute serially, asynchronously, concurrently, in parallel, simultaneously, synchronously, and/or the like in a manner consistent with the disclosure. As such, some of these features can be mutually contradictory, in that they cannot be simultaneously present in a single embodiment. Similarly, some features are applicable to one aspect of the innovations, and inapplicable to others.

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

As used herein, the term “state variables” refers to measurable thermodynamic properties of a fluid that can be used to characterize, compare, or control system operation. Such properties include, without limitation, composition, temperature, pressure, entropy, enthalpy, density, flow rate, or combinations thereof.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B.” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also referred to herein as code) can be designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules can include, for example, a processor, a field programmable gate array (FPGA), and/or an application specific integrated circuit (ASIC). Software modules (executed on hardware) can include instructions stored in a memory that is operably coupled to a processor and can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

### ENUMERATED EMBODIMENTS

The aspects of the present disclosure are further described with reference to the following numbered embodiments:

1. An apparatus, comprising:
an engine including a reactor chamber; and
a plurality of inlets coupled to the reactor chamber, the plurality of inlets including:
   a first inlet configured to deliver a reactant stream, and
   at least two oxidizer inlets configured to deliver at least two oxidizer streams;
wherein the reactor chamber is configured to receive the reactant stream and the at least two oxidizer streams to conduct a reaction therebetween to produce a product.

2. The apparatus of embodiment 1, wherein the engine is a reciprocating machine.

3. The apparatus of embodiment 2, wherein the reciprocating machine is an internal combustion engine.

4. The apparatus of embodiment 3, wherein the internal combustion engine is selected from a spark-ignition engine, a compression-ignition engine, a homogeneous charge compression-ignition (HCCI) engine, or combinations thereof.

5. The apparatus of any one of embodiments 1-3, wherein the reactant stream includes gaseous hydrocarbons.

6. The apparatus of embodiment 5, wherein the reactant stream includes a hydrocarbon-rich fuel gas containing nitrogen.

7. The apparatus of embodiment 5 or 6, wherein the reactant stream further comprises carbon dioxide.

8. The apparatus of any one of embodiments 5-7, wherein the reactant stream further comprises oxygen.

9. The apparatus of any one of embodiments 5-8, wherein the reactant stream is landfill gas, biogas, or tailgas from a nitrogen rejection unit in a renewable natural gas upgrading facility.

10. The apparatus of any one of embodiments 1-9, wherein an oxidizer stream from the at least two oxidizer streams includes ambient air.

11. The apparatus of any one of embodiments 1-10, wherein an oxidizer from the at least two oxidizer streams includes oxygen or oxygen-enriched air.

12. The apparatus of embodiment 11, wherein the oxygen-enriched air comprises between 50 vol. % and 99 vol. % oxygen.

13. The apparatus of embodiment 11 or 12, wherein the oxygen-enriched air is produced by an air separation unit.

14. The apparatus of embodiment 13, wherein the air separation unit is a pressure swing adsorption (PSA) unit.

15. The apparatus of embodiment 13, wherein the air separation unit is a vacuum pressure swing adsorption (VPSA) unit.

16. The apparatus of embodiment 13, wherein the air separation unit is a membrane separation unit.

17. The apparatus of any one of embodiments 1-16, wherein a first and a second oxidizer stream from the at least two oxidizer streams differ in oxygen concentration by at least 20 vol. %.

18. The apparatus of any one of embodiments 1-16, wherein a first and a second oxidizer stream from the at least two oxidizer streams differ in nitrogen concentration by at least 20 vol. %.

19. The apparatus of any one of embodiments 1-16, wherein the at least two oxidizer streams include a first and a second oxidizer stream, the first oxidizer stream having an oxygen concentration higher than that of the second oxidizer stream, the first oxidizer stream having a supply pressure greater than a supply pressure of the second oxidizer stream.

20. The apparatus of any one of embodiments 1-19, wherein the at least two oxidizer streams differ in specific entropy by at least 0.4 KJ/kg K at 298 K.

21. The apparatus of any one of embodiments 1-20, wherein the at least two oxidizer streams collectively include between 21 vol. % and 99 vol. % oxygen.

22. The apparatus of any one of embodiments 1-21, wherein the at least two oxidizer streams collectively include between 1 vol. % and 79 vol. % inert gases.

23. The apparatus of embodiment 22, wherein the inert gases comprise nitrogen and argon.

24. The apparatus of any one of embodiments 1-23, wherein the reaction comprises partial oxidation reforming of hydrocarbons.

25. The apparatus of any one of embodiments 1-24, wherein the reactor chamber is further configured to produce power harvested mechanically or electrically.

26. The apparatus of embodiment 25, wherein at least a portion of the power is used to operate an air separation unit coupled to the engine.

27. The apparatus of any one of embodiments 1-26, wherein the product includes synthesis gas, the synthesis including H₂, CO, H₂O, N₂, CO₂, Ar, CH₄ and O₂.

28. The apparatus of embodiment 27, wherein the synthesis gas includes H₂ at a concentration greater than 20 vol. %, 30 vol. %, 40 vol. %, or 50 vol. %.

29. The apparatus of embodiment 27 or 28, wherein the synthesis gas includes inert gases in a concentration no more than about 50 vol. %, 40 vol. %, 30 vol. %, 20 vol. %, or 10 vol. %.

30. The apparatus of any one of embodiments 27-29, wherein the synthesis gas has an H₂/CO ratio greater than 1.0, 1.2, 1.4, or 1.6.

31. The apparatus of any one of embodiments 27-30, wherein the synthesis gas has a stoichiometric number (SN) greater than 1.0.

32. The apparatus of any one of embodiments 1-31, wherein the at least two oxidizer inlets are configured to supply variable relative contributions of the at least two oxidizer streams such that a combined oxidizer stream has a variable oxygen concentration during operation.

33. The apparatus of embodiment 3, wherein the internal combustion engine includes a conduit to redirect blowby gases from a crankcase of the reactor chamber to an inlet of the engine.

34. The apparatus of embodiment 3 or 33, wherein the internal combustion engine includes variable valve timing to regulate an amount of residual hydrogen-rich gas retained in one or more cylinders.

35. The apparatus of any one of embodiments 1-34, wherein the reactor is configured to regulate oxidizer flow to prevent misfire and to maintain reactant concentration in a reactant-oxidizer mixture at a level that prevents misfire.

36. A method of operating a reactor, comprising:
supplying a reactant stream to a reactor chamber included in the reactor;
supplying at least two oxidizer streams to the reactor chamber, the at least two oxidizer streams being supplied individually or in combination; and
conducting a reaction between the reactant stream and the at least two oxidizer streams in the reactor chamber to produce a product.

37. The method of embodiment 36, wherein the reactor is a reciprocating machine.

38. The method of embodiment 37, wherein the reciprocating machine is an internal combustion engine.

39. The method of embodiment 38, wherein the internal combustion engine is selected from a spark-ignition engine, a compression-ignition engine, a homogeneous charge compression-ignition (HCCI) engine, or combinations thereof.

40. The method of any one of embodiments 36-39, wherein the reactant stream includes gaseous hydrocarbons.

41. The method of any one of embodiments 36-40, wherein the reactant stream includes a hydrocarbon-rich fuel gas containing nitrogen.

42. The method of any one of embodiments 36-41, wherein the reactant stream further includes carbon dioxide.

43. The method of any one of embodiments 36-42, wherein the reactant stream further includes oxygen.

44. The method of any one of embodiments 36-43, wherein the reactant stream includes landfill gas, biogas, or tailgas from a nitrogen rejection unit in a renewable natural gas upgrading facility.

45. The method of any one of embodiments 36-44, wherein an oxidizer stream from the at least two oxidizer streams includes ambient air.

46. The method of embodiment 45, wherein an oxidizer stream from the at least two oxidizer streams includes oxygen or oxygen-enriched air.

47. The method of embodiment 46, wherein the oxygen-enriched air includes between 50 vol. % and 99 vol. % oxygen.

48. The method of embodiment 46 or 47, wherein the oxygen-enriched air is produced by an air separation unit.

49. The method of embodiment 48, wherein the air separation unit is a pressure swing adsorption (PSA) unit.

50. The method of embodiment 48, wherein the air separation unit is a vacuum pressure swing adsorption (VPSA) unit.

51. The method of embodiment 48, wherein the air separation unit is a membrane separation unit.

52. The method of any one of embodiments 36-51, wherein a first and a second oxidizer stream from the at least two oxidizer streams differ in oxygen concentration by at least 20 vol. %.

53. The method of any one of embodiments 36-51, wherein a first and a second oxidizer stream from the at least two oxidizer streams differ in nitrogen concentration by at least 20 vol. %.

54. The method of any one of embodiment 36-51, wherein a first and a second oxidizer stream from the at least two oxidizer streams differ in specific entropy by at least 0.4 KJ/kg·K at 298 K.

55. The method of any one of embodiments 36-51, wherein a first and a second oxidizer stream from the at least two oxidizer streams differ in supply pressure by at least 0.1 bar.

56. The method of any one of embodiments 36-51, wherein the at least two oxidizer streams include a first and a second oxidizer stream, the first oxidizer stream having an oxygen concentration higher than that of the second oxidizer stream, the first oxidizer stream having a supply pressure greater than a supply pressure of the second oxidizer stream.

57. The method of any one of embodiments 36-56, further comprising:

regulating a flow of each oxidizer stream form the at least two oxidizer streams with separate flow control devices.

58. The method of embodiment 57, wherein a controller operably coupled to the separate flow control devices is configured to adjust a relative contribution each oxidizer stream from the at least two oxidizer streams based on a difference in at least one of an oxygen concentration, a nitrogen concentration, an entropy, or a pressure between each oxidizer stream from the at least two oxidizer streams.

59. The method of embodiment 58, wherein the controller adjusts each oxidizer streams to maintain a target equivalence ratio, a target engine speed or power, a target intake pressure, a desired adiabatic temperature rise, peak pressure, pressure rise rate, or an exhaust temperature in the reactor.

60. The method of embodiment 58, wherein the controller adjusts each oxidizer stream to maintain a target compression behavior or surge margin in an oxidizer compressor coupled to the reactor.

61. The method of any one of embodiments 36-60, wherein the reaction comprises partial oxidation reforming of hydrocarbons.

62. The method of any one of embodiments 36-61, wherein the reactor produces power that is harvested mechanically or electrically.

63. The method of embodiment 62, wherein at least a portion of the power is used to operate an air separation unit coupled to the reactor.

64. The method of any one of embodiments 36-63, wherein the product includes synthesis gas, the synthesis gas including H₂, CO, H₂O, N₂, CO₂, Ar, CH₄ and O₂.

65. The method of embodiment 64, wherein the synthesis gas comprises H₂ in an amount greater than 20 vol. %, 30 vol. %, 40 vol. %, or 50 vol. %.

66. The method of embodiment 64 or 65, wherein the synthesis gas comprises N₂ in an amount less than 50 vol. %, 40 vol. %, 30 vol. %, 20 vol. %, or 10 vol. %.

67. The method of any one of embodiments 64-66, wherein the synthesis gas has an H₂/CO ratio greater than 1.0, 1.2, 1.4, or 1.6.

68. The method of any one of embodiments 64-67, wherein the synthesis gas has a stoichiometric number (SN) greater than 1.0.

69. The method of any one of embodiment 36-68, further comprising:
varying a flow of the at least two oxidizer streams such that a combined oxidizer stream has a variable oxygen concentration during operation of the reactor.

70. The method of embodiment 38, further comprising:
redirecting blowby gases from a crankcase of the internal combustion engine to an inlet of the internal combustion engine.

71. The method of embodiment 38 or 70, wherein the internal combustion engine includes variable valve timing, and operating the engine comprises regulating the valve timing to control an amount of residual hydrogen-rich gas retained in one or more cylinders.

72. The method of any one of embodiments 1-71, further comprising:
regulating oxidizer flow such that misfire is prevented and reactant concentration in the reactant-oxidizer mixture at a level that prevents misfire.

73. A control system for a reactor, the control system comprising:
a plurality of flow control devices configured to regulate at least two oxidizer streams of differing state variables;
one or more sensors configured to measure one or more parameters of the at least two oxidizer streams, the reactor operation, or both; and
a controller operably coupled to the plurality of flow control devices and the one or more sensors, the controller configured to:
   recognize differences between the at least two oxidizer streams based on their state variables; and
   adjust a flow of the at least two oxidizer streams supplied to a reactor chamber in response to the measured one or more parameters.

74. The control system of embodiment 73, wherein the one or more sensors are further configured to measure parameters of a reactant stream supplied to the reactor chamber.

75. The control system of embodiment 73 or 74, further comprising:
at least one sensor configured to measure an outlet stream of the reactor.

76. The control system of embodiment 75, wherein the at least one sensor includes a lambda sensor, a gas analyzer, or an oxygen sensor.

77. The control system of embodiment 75, wherein the at least one sensor is configured to measure at least one of: oxygen concentration, hydrogen concentration, carbon monoxide concentration, H₂/CO ratio, stoichiometric number (SN), or residual oxygen.

78. The control system of any one of embodiments 73-77, wherein the reactor is configured to receive one or more reactant streams including gaseous hydrocarbons.

79. The control system of embodiment 78, wherein the one or more reactant streams include landfill gas, biogas, or tailgas from a nitrogen rejection unit.

80. The control system of embodiment 78 or 79, wherein the one or more reactant streams include a hydrocarbon-rich gas containing nitrogen, carbon dioxide, or oxygen in addition to hydrocarbons.

81. The control system of any one of embodiments 78-80, wherein the controller is further configured to regulate a flow of the one or more reactant streams in response to one or more of the at least two oxidizer streams, the reactor operation, or both.

82. The control system of any one of embodiments 73-81, wherein the state variables comprise composition, pressure, temperature, entropy, or density.

83. The control system of any one of embodiments 73-82, wherein the controller distinguishes between ambient air and oxygen-enriched air.

84. The control system of any one of embodiments 73-83, wherein the controller identifies an oxygen-enriched stream having an oxygen concentration between 50 vol. % and 99 vol. % and an entropy at least 0.4 KJ/kg·K lower than ambient air.

85. The control system of embodiment 78, wherein the controller adjusts one or more of the at least two oxidizer streams and the reactant stream to maintain a target equivalence ratio in the reactor.

86. The control system of embodiment 78, wherein the controller adjusts one or more of the at least two oxidizer streams and the reactant stream to maintain one or more of: a desired adiabatic temperature rise, peak pressure, pressure rise rate, or exhaust temperature in the reactor.

87. The control system of embodiment 78, wherein the controller adjusts one or more of the at least two oxidizer streams and the reactant stream to maintain compressor operation within a surge margin.

88. The control system of embodiment 78, wherein the controller adjusts one or more of the at least two oxidizer streams and the reactant stream to achieve a target synthesis gas stoichiometric number (SN).

89. The control system of embodiment 78, wherein the controller adjusts one or more of the at least two oxidizer streams and the reactant stream to achieve a target hydrogen-to-carbon monoxide (H₂/CO) ratio in the synthesis gas.

90. The control system of embodiment 78, wherein the reactor comprises an internal combustion engine, and the controller adjusts one or more of the oxidizer streams and the reactant stream to maintain a desired operating speed and/or power output of the internal combustion engine.

91. The control system of embodiment 78, further comprising independent feedback loops configured to regulate one or more of the at least two oxidizer streams and the reactant stream.

92. The control system of embodiment 91, wherein the feedback loops are configured to balance contributions of one or more of the at least two oxidizer streams and the reactant stream according to real-time measurements of reactor performance.

93. The control system of any one of embodiments 73-92, wherein the reactor is configured to produce power, and the control system is operably coupled to a power harvesting device selected from a mechanical shaft, an electrical generator, or combinations thereof.

94. The control system of any one of embodiments 73-93, wherein the controller adjusts relative contributions of the at least two oxidizer streams such that a combined oxidizer stream has a variable oxygen concentration during operation.

95. The control system of any one of embodiments 73-94, wherein the controller is further configured to regulate a flow path that redirects blowby gases from a crankcase of the reactor to an inlet of the reactor.

96. The control system of any one of embodiments 73-95, wherein the reactor comprises a spark-ignition engine, and the controller is further configured to adjust spark timing in response to one or more of the at least two oxidizer streams, the reactant stream, or reactor operation parameters.

97. The control system of any one of embodiments 73-96, wherein the reactor comprises an internal combustion engine having variable valve timing, and the controller is further configured to adjust valve timing to regulate the amount of residual hydrogen-rich gas retained in a cylinder, thereby improving engine stability and reactant conversion.

98. The control system of any one of embodiments 73-97, wherein the controller is configured to adjust oxidizer flow to prevent misfire and to maintain reactant concentration in the reactant-oxidizer mixture at a level that prevents misfire.

99. A method of controlling a reactor, the method comprising:
receiving at least two oxidizer streams of differing state variables;
supplying the at least two oxidizer streams and at least one reactant stream to a reactor chamber included in the reactor;
measuring one or more parameters of the at least two oxidizer streams, the reactor operation, or both; and
adjusting one or more of the at least two oxidizer streams and the reactant stream in response to the measured parameters.

100. The method of embodiment 99, further comprising:
measuring one or more parameters of the reactant stream supplied to the reactor chamber.

101. The method of embodiment 99, further comprising:
measuring an outlet stream of the reactor.

102. The method of embodiment 101, wherein measuring the outlet stream includes using at least one of: a lambda sensor, a gas analyzer, or an oxygen sensor.

103. The method of embodiment 101, wherein measuring the outlet stream includes determining at least one of: oxygen concentration, hydrogen concentration, carbon monoxide concentration, H₂/CO ratio, stoichiometric number (SN), or residual oxygen.

104. The method of any one of embodiments 99-103, further comprising:
identifying differences between the at least two oxidizer streams based on one or more state variables selected from composition, pressure, temperature, entropy, or density.

105. The method of any one of embodiments 99-104, wherein the at least two oxidizer streams include ambient air and oxygen-enriched air.

106. The method of embodiment 105, wherein the oxygen-enriched air has an oxygen concentration between 50 vol. % and 99 vol. % and an entropy at least 0.4 KJ/kg. K lower than ambient air.

107. The method of any one of embodiments 99-106, wherein adjusting includes regulating one or more of the at least two oxidizer streams and the reactant stream to maintain a target equivalence ratio in the reactor.

108. The method of any one of embodiments 99-107, wherein adjusting includes regulating one or more of the at least two oxidizer streams and the reactant stream to maintain a desired adiabatic temperature rise in the reactor.

109. The method of any one of embodiments 99-108, wherein adjusting includes regulating one or more of the at least two oxidizer streams and the reactant stream to maintain compressor operation within a surge margin.

110. The method of any one of embodiments 99-109, wherein adjusting includes regulating one or more of the at least two oxidizer streams and the reactant stream to achieve a target synthesis gas stoichiometric number (SN).

111. The method of any one of embodiments 99-110, wherein adjusting includes regulating one or more of the at least two oxidizer streams and the reactant stream to achieve a target hydrogen-to-carbon monoxide (H₂/CO) ratio in the synthesis gas.

112. The method of any one of embodiments 99-111, wherein the reactor includes an internal combustion engine, and adjusting includes regulating one or more of the oxidizer streams and the reactant stream to maintain a desired operating speed and/or power output of the engine.

113. The method of any one of embodiments 99-112, further comprising:
executing independent feedback loops to regulate one or more of the at least two oxidizer streams and the reactant stream.

114. The method of embodiment 113, wherein the feedback loops balance contributions of the at least two oxidizer streams and the reactant stream according to real-time measurements of reactor performance.

115. The method of any one of embodiments 99-114, wherein adjusting includes varying relative contributions of the at least two oxidizer streams such that a combined oxidizer stream has a variable oxygen concentration during operation of the reactor.

116. The method of any one of embodiments 99-115, further comprising:
controlling a flow path that redirects blowby gases from a crankcase of the reactor to an inlet of the reactor chamber.

117. The method of embodiment 99, wherein the reactor comprises a spark-ignition engine, and the method further comprises:
adjusting spark timing in response to one or more of the at least two oxidizer streams, the reactant stream, or reactor operation parameters.

118. The method of embodiment 99, wherein the reactor comprises an internal combustion engine having variable valve timing, and the method further comprises:
adjusting valve timing to regulate an amount of residual hydrogen-rich gas retained in a cylinder to improve engine stability and reactant conversion.

119. The method of embodiment 99, further comprising:
adjusting oxidizer flow with the controller to prevent misfire and to maintain reactant concentration in the reactant-oxidizer mixture at a level that prevents misfire.

1.-22. (canceled)

23. A method of operating a reactor, comprising:
supplying a reactant stream to a reactor chamber included in the reactor;
supplying at least two oxidizer streams to the reactor chamber, the at least two oxidizer streams being supplied individually or in combination; and
conducting a reaction between the reactant stream and the at least two oxidizer streams in the reactor chamber to produce a product.

24. The method of claim 23, wherein the reactor is a reciprocating machine.

25. The method of claim 24, wherein the reciprocating machine is an internal combustion engine selected from a spark-ignition engine, a compression-ignition engine, a homogeneous charge compression-ignition (HCCI) engine, or combinations thereof.

26. The method of claim 23, wherein the reactant stream includes a hydrocarbon-rich fuel gas containing at least one of nitrogen, carbon dioxide, or oxygen.

27. The method of claim 23, wherein the reactant stream includes landfill gas, biogas, or tailgas from a nitrogen rejection unit in a renewable natural gas upgrading facility.

28. The method of claim 23, wherein an oxidizer stream from the at least two oxidizer streams includes ambient air.

29. The method of claim 23, wherein an oxidizer stream from the at least two oxidizer streams includes oxygen or oxygen-enriched air, the oxygen-enriched air including between about 50 vol. % and 99 vol. % oxygen.

30. The method of claim 29, wherein the oxygen-enriched air is produced by an air separation unit, the air separation unit including one of a pressure swing adsorption (PSA) unit, a vacuum pressure swing adsorption (VPSA) unit, or a membrane separation unit.

31. The method of claim 23, wherein a first and a second oxidizer stream from the at least two oxidizer streams differ in oxygen concentration by at least 20 vol. %.

32. The method of claim 23, wherein a first and a second oxidizer stream from the at least two oxidizer streams differ in nitrogen concentration by at least 20 vol. %.

33. The method of claim 23, wherein a first and a second oxidizer stream from the at least two oxidizer streams differ in specific entropy by at least 0.4 KJ/kg K at 298 K.

34. The method of claim 23, wherein a first and a second oxidizer stream from the at least two oxidizer streams differ in supply pressure by at least 0.1 bar.

35. The method of claim 23, wherein the at least two oxidizer streams include a first and a second oxidizer stream, the first oxidizer stream having an oxygen concentration higher than that of the second oxidizer stream, the first oxidizer stream having a supply pressure greater than a supply pressure of the second oxidizer stream.

36. The method of claim 23, further comprising:
regulating a flow of each oxidizer stream form the at least two oxidizer streams with separate flow control devices.

37. The method of claim 36, wherein a controller operably coupled to the separate flow control devices is configured to adjust a relative contribution each oxidizer stream from the at least two oxidizer streams based on a difference in at least one of an oxygen concentration, a nitrogen concentration, an entropy, or a pressure between each oxidizer stream from the at least two oxidizer streams.

38. The method of claim 37, wherein the controller adjusts each oxidizer streams to maintain a target equivalence ratio, a target engine speed or power, a target intake pressure, a desired adiabatic temperature rise, peak pressure, pressure rise rate, or an exhaust temperature in the reactor.

39. The method of claim 23, wherein the reaction includes partial oxidation reforming of hydrocarbons.

40. The method of claim 23, further comprising:
producing power with the reactor, the produced power being harvested mechanically or electrically.

41. The method of claim 40, wherein at least a portion of the produced power is used to operate an air separation unit coupled to the reactor.

42. The method of claim 23, wherein the product includes synthesis gas, the synthesis gas including H₂, CO, H₂O, N₂, CO₂, Ar, CH₄ and O₂, the H₂ having a concentration greater than at least 20 vol. % 30 vol. %, 40 vol. %, or 50 vol. %, and the N₂ having a concentration of less than 50 vol. %, 40 vol. %, 30 vol. %, 20 vol. %, or 10 vol. %.

43. The method of claim 42, wherein the synthesis gas has an H₂/CO ratio greater than 1.0, 1.2, 1.4, or 1.6.

44. The method of claim 42, wherein the synthesis gas has a stoichiometric number (SN) greater than 1.0.

45. The method of claim 23, further comprising:
varying a flow of the at least two oxidizer streams such that a combined oxidizer stream has a variable oxygen concentration during operation of the reactor.

46. The method of claim 25, further comprising:
redirecting blowby gases from a crankcase of the internal combustion engine to an inlet of the internal combustion engine.

47. The method of claim 25, wherein the internal combustion engine includes variable valve timing, and operating the engine comprises regulating the valve timing to control an amount of residual hydrogen-rich gas retained in one or more cylinders.

48. The method of claim 23, further comprising:
regulating a flow of each oxidizer stream from the at least two oxidizer streams such that misfire is prevented and a reactant concentration in a reactant-oxidizer mixture is kept at a level that prevents misfire.
